(19) United States
(12) Patent Application Publication
(10) Pub. No.: US 2025/0309344 A1
(43) Pub. Date: Oct. 2, 2025

(54) ALKALI METAL PF6 SALT STABILIZATION IN CARBONATE SOLUTIONS

(71) Applicant: Silatronix, Inc., Madison, WI (US)

(72) Inventors: José Adrián Peña Hueso, Madison, WI (US); Monica Usrey, Madison, WI (US); Arthur Homa, Langley, WA (US); Mark Zager, Belgium, WA (US); Suresh Sriramulu, Arlington, MA (US); Deborah Gilbert, Fitchburg, WI (US)

(73) Assignee: Silatronix, Inc., Madison, WI (US)

(21) Appl. No.: 18/864,302

(22) PCT Filed: May 9, 2023
(86) PCT No.: PCT/US2023/021495

§ 371 Date: Nov. 8, 2024

Related U.S. Application Data
(60) Provisional application No. 63/339,599, filed on May 9, 2022.

(51) Int. Cl. H01M 10/0567; C07F 7/12; H01M 10/0525; H01M 10/0568; H01M 10/0569

(52) U.S. Cl. CPC H01M 10/0567; C07F 7/123; H01M 10/0568; H01M 10/0569; H01M 10/0525; H01M 2300/0028

(57) ABSTRACT

Disclosed herein is a stabilized salt-in-solvent mixture comprising a salt, a carbonate solvent, and an organosilicon (OS) compound, wherein the OS compound suppresses degradation reactions within the salt-in-solvent mixture. Also disclosed herein is a method of mitigating degradation of a salt/carbonate solution comprising adding to the salt/carbonate solution an amount of an OS compound that suppresses degradation reactions within the salt/carbonate solution. This OS compound may be added to the carbonate solvent before or after dissolution of the salt to form the salt-in-solvent mixture.

### BACKGROUND

Lithium hexafluorophosphate (LiPF₆) is the most common lithium salt used in lithium-ion battery technology today. While it has many useful properties as a battery ionic conductor, the material has considerable sensitivity to degradation through several different mechanisms. These various degradation routes are accelerated at elevated temperatures. This degradation is an on-going problem even before the LiPF₆ is formulated into an electrolyte and then incorporated into a battery. Prior to the salt reaching a battery, it must be stored and then passed through the multi-step process of electrolyte formulation and production. Throughout the storage and electrolyte production process, the salt is susceptible to degradation which ultimately lowers the performance of the battery into which it is incorporated. Other candidate alkali metal salts include NaPF₆ which suffers from these same issues.

Thus, there is a long-felt unmet need for mitigating degradation of the electrolyte salts in either simple or complex solvent systems.

### SUMMARY OF THE INVENTION

Disclosed herein is a stabilized salt-in-solvent mixture for use in electrolyte formulations for lithium-ion charge storage devices (such as batteries). The mixture comprises a salt, a carbonate solvent, and an organosilicon (OS) compound as disclosed herein, wherein the OS compound suppresses degradation reactions within the salt-in-solvent mixture. Also disclosed herein is a corresponding method to increase the storage stability of LiPF₆- or NaPF₆-containing compositions by inhibiting thermal and chemical degradation in the compositions. This is done by incorporation to the compositions of one or more OS compounds as disclosed herein.

In certain versions, the stabilized salt-in-solvent mixture comprises an alkali metal salt such as LiPF₆ or NaPF₆, a linear carbonate such as ethyl methyl carbonate (EMC), and an OS compound.

Also disclosed herein is a method of mitigating degradation of a salt/carbonate solution for use in electrolyte formulations or in the formulated electrolytes per se, both before and after the electrolytes are incorporated into a lithium-ion battery or other charge-storage device. The method comprises adding to the salt/carbonate solution an amount of an OS compound that suppresses degradation reactions within the salt/carbonate solution. This OS compound may be added to the carbonate solvent before or after dissolution of the salt to form the salt-in-solvent mixture.

The OS compound used herein is selected from the group consisting of:

(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and

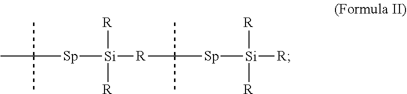

wherein each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of an organic polar group.

In certain versions of the compounds, each “Y” is independently an organic polar group selected from the group consisting of:

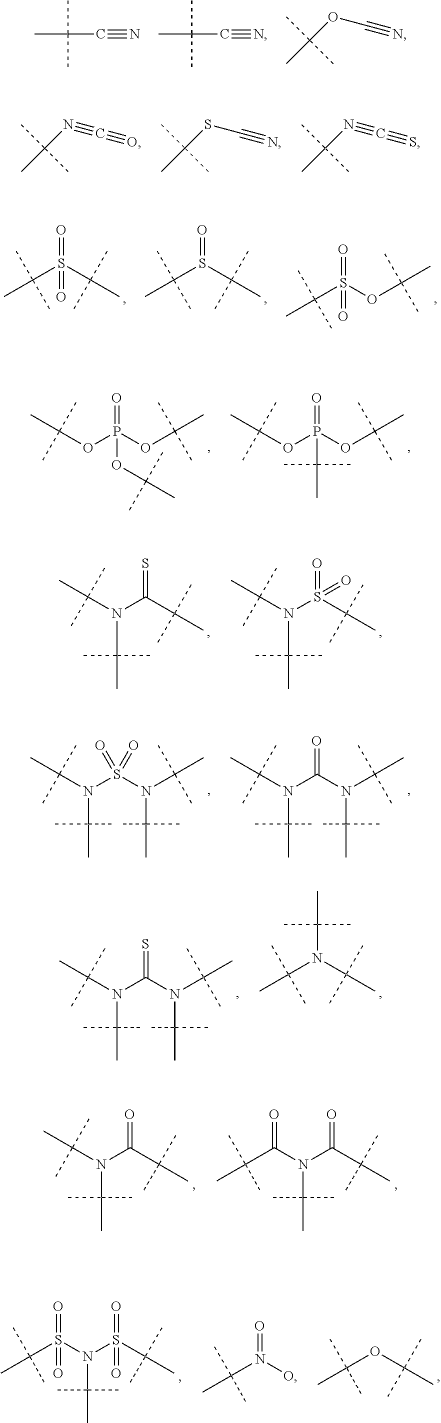

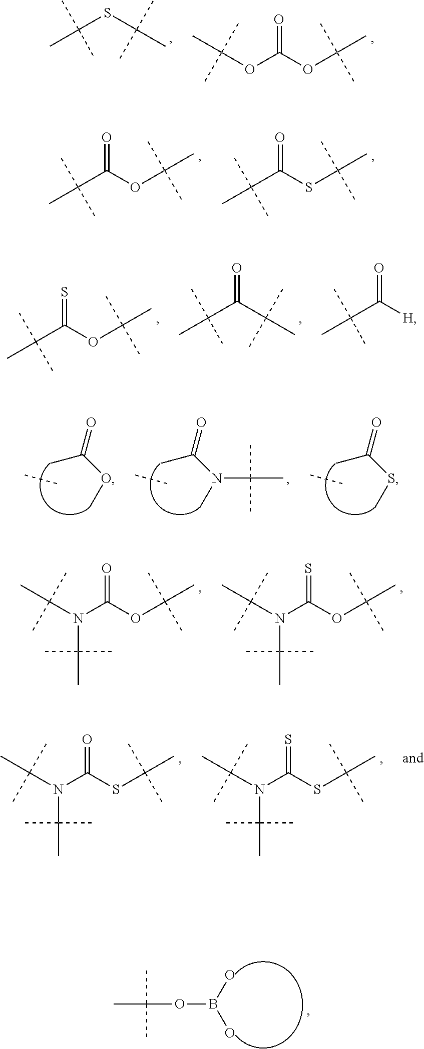

wherein a curved bond denotes a C₂₋₆ alkylene bridging moiety.

An exemplary OS compound within the scope of the disclosure is F1S₃MN (4-(fluorodimethylsilyl) butanenitrile) having the structure:

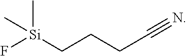

An exemplary OS compound within the scope of the disclosure is DF1S₂MN (3-(difluorodimethylsilyl) propanenitrile) having the structure:

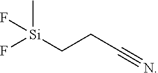

Specifically, the following compositions and methods are disclosed and claimed herein:

1. A stabilized salt-in-solvent mixture, the mixture comprising a salt, a carbonate solvent; and an organosilicon compound, wherein the organosilicon compound inhibits degradation reactions within the salt-in-solvent mixture.

2. The stabilized salt-in-solvent mixture of claim 1, wherein the salt is an alkali metal PF₆ salt.

3. The stabilized salt-in-solvent mixture of claim 2, wherein the salt is selected from the group consisting of LiPF₆ and NaPF₆.

4. The stabilized salt-in-solvent mixture of claim 2, wherein the carbonate is a linear carbonate.

5. The stabilized salt-in-solvent mixture of claim 2, wherein the carbonate is selected from the group consisting of ethyl methyl carbonate, dimethyl carbonate, and diethyl carbonate, ethylene carbonate, propylene carbonate, and γ-butyrolactone.

6. The stabilized salt-in-solvent mixture of claim 2, wherein the organosilicon compound is selected from the group consisting of:

(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and

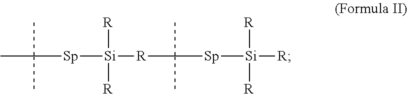

where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of an organic polar group.

7. The stabilized salt-in-solvent mixture of claim 6, wherein each “Y” is independently an organic polar group selected from the group consisting of:

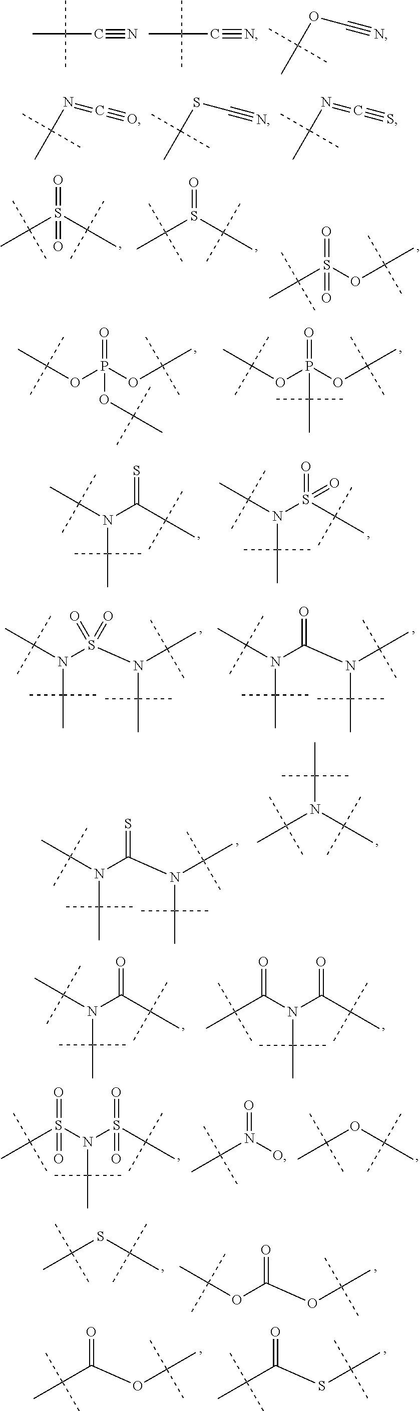

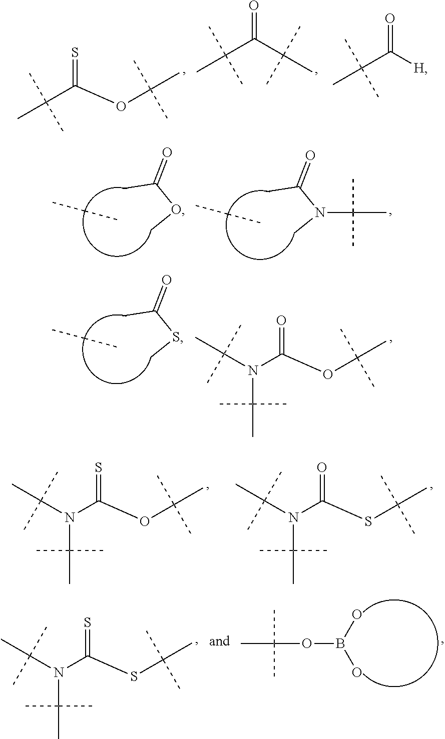

wherein a curved bond denotes a C₂₋₆ alkylene bridging moiety.

8. The stabilized salt-in-solvent mixture of claim 7, wherein each “Y” is independently an organic polar group selected from the group consisting of:

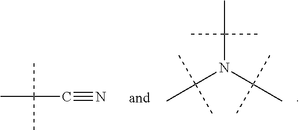

9. The stabilized salt-in-solvent mixture of claim 2, wherein the organosilicon compound is:

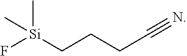

10. The stabilized salt-in-solvent mixture of claim 2, wherein the organosilicon compound is:

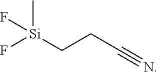

11. The stabilized salt-in-solvent mixture of any one of claims 1-10 for use in electrolyte formulation.

12. A stabilized salt-in-solvent mixture, the mixture comprising an alkali metal PF₆ salt, a carbonate solvent; and an organosilicon compound selected from the group consisting of:

(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and

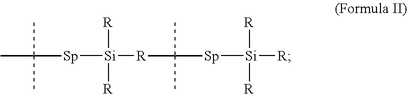

where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of:

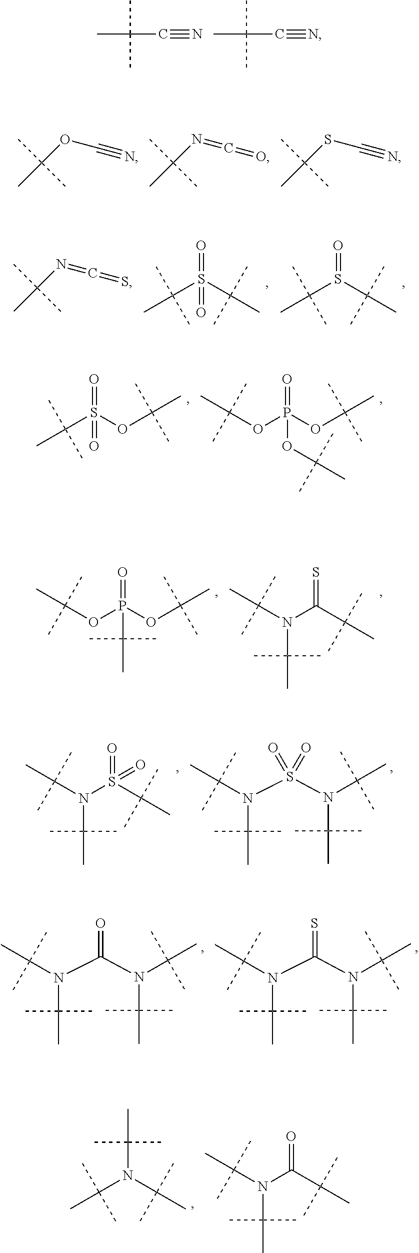

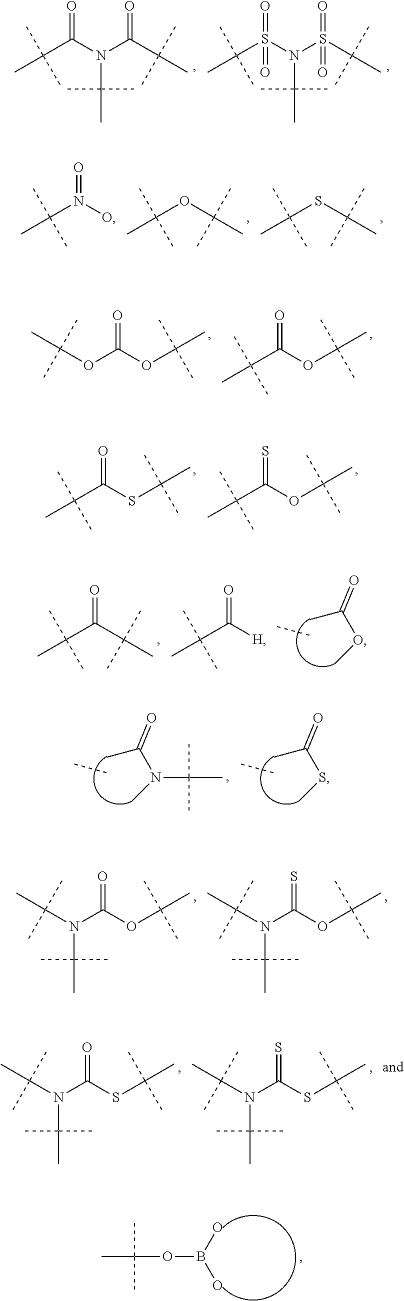

wherein a curved bond denotes a C₂₋₆ alkylene bridging moiety;
wherein the organosilicon compound inhibits degradation reactions within the salt-in-solvent mixture.

13. The stabilized salt-in-solvent mixture of claim 12, wherein the carbonate is selected from the group consisting of ethyl methyl carbonate, dimethyl carbonate, and diethyl carbonate, ethylene carbonate, propylene carbonate, and γ-butyrolactone.

14. The stabilized salt-in-solvent mixture of claim 12, wherein each “Y” is independently an organic polar group selected from the group consisting of:

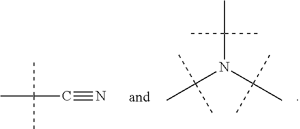

15. The stabilized salt-in-solvent mixture of claim 12, wherein the organosilicon compound is:

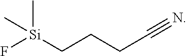

16. The stabilized salt-in-solvent mixture of claim 12, wherein the organosilicon compound is:

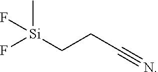

17. The stabilized salt-in-solvent mixture of claim 12, wherein the salt is selected from the group consisting of LiPF₆ and NaPF₆.

18. The stabilized salt-in-solvent mixture of any one of claims 12-17 for use in electrolyte formulation.

19. A method of mitigating degradation of a salt/carbonate solution for use in electrolyte formulation or in a formulated electrolyte, the method comprising adding to the salt/carbonate solution an amount of an organosilicon compound selected from the group consisting of:

(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and

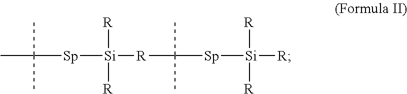

where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of:

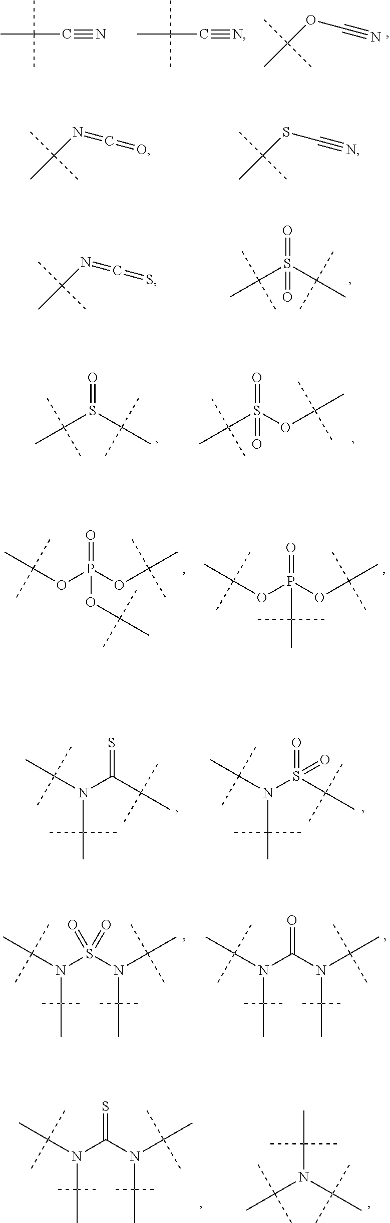

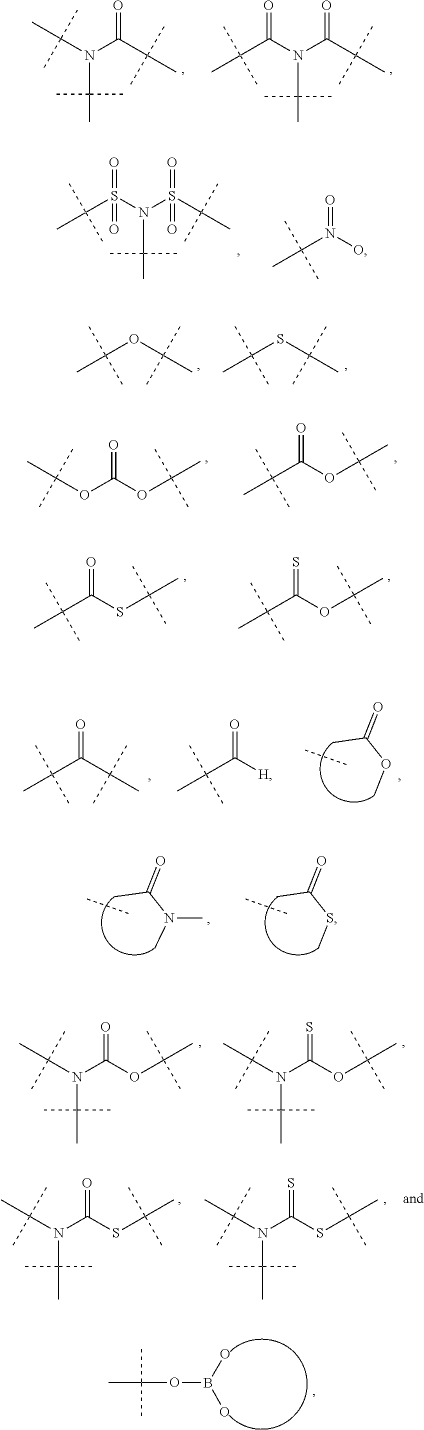

wherein a curved bond denotes a C₂₋₆ alkylene bridging moiety;
wherein the organosilicon compound inhibits degradation reactions within the salt-in-solvent mixture.

20. A stabilized salt-in-solvent mixture, the mixture comprising an alkali metal PF₆ salt, a carbonate solvent; and an organosilicon compound, wherein hydrofluoric acid (HF) concentration in the mixture is less than about 100 ppm after 20 days of storage at 100° C.

21. The stabilized salt-in-solvent mixture of claim 20, wherein hydrofluoric acid (HF) concentration in the mixture is less than about 20 ppm after 20 days of storage at 100° C.

22. The stabilized salt-in-solvent mixture of claim 20, wherein hydrofluoric acid (HF) concentration in the mixture is less than about 10 ppm after 20 days of storage at 100° C.

23. The stabilized salt-in-solvent mixture of claim 20, wherein hydrofluoric acid (HF) concentration in the mixture is less than about 5 ppm after 20 days of storage at 100° C.

24. The stabilized salt-in-solvent mixture of claim 20, wherein the organosilicon compound is selected from the group consisting of:

(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and

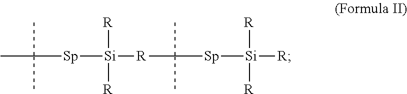

where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of:

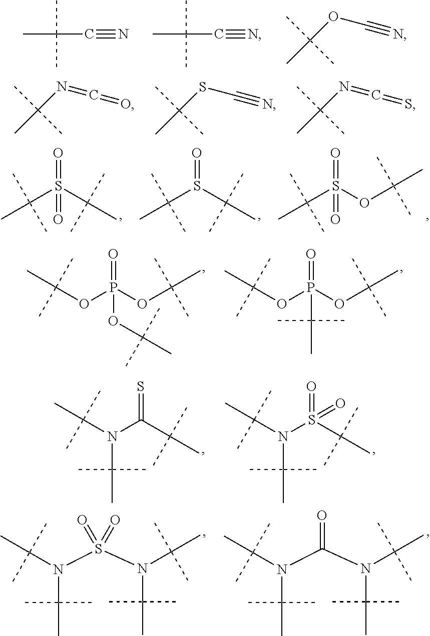

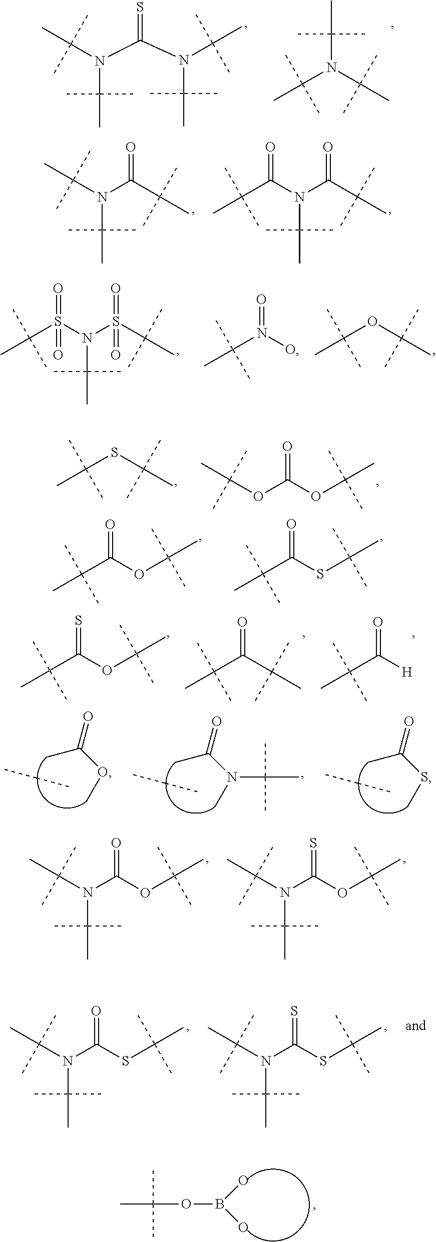

wherein a curved bond denotes a C₂₋₆ alkylene bridging moiety;
wherein the organosilicon compound inhibits degradation reactions within the salt-in-solvent mixture.

25. The stabilized salt-in-solvent mixture of claim 20, wherein the carbonate is selected from the group consisting of ethyl methyl carbonate, dimethyl carbonate, and diethyl carbonate, ethylene carbonate, propylene carbonate, and γ-butyrolactone.

26. The stabilized salt-in-solvent mixture of claim 20, wherein concentration of the organosilicon compound is calculated using the formula:

$$( Vol {\%}_{OS} ) = \frac{[ ppm {H}_{2} O ]}{\begin{matrix}( {ρ}_{OS} ) * ( \frac{1}{M {W}_{OS}} ) * ( \frac{1 mol H F}{1 mol OS} ) * \\ ( \frac{1 mol {H}_{2} O}{2 mol H F} ) * ( M {W}_{H 2 O} ) * ( 1000 ) * ( \frac{1}{{ρ}_{sol}} ) * ( 10 )\end{matrix}}$$

Where Vol %_{OS} is the calculated concentration of organosilicon compound, [ppm H₂O] is the measured concentration of water in the salt-in-solvent mixture, ρ_{OS} is the density of the organosilicon compound, ρₛₒₗ is the density of the solvent mixture, MW_{OS} is the molecular weight of the organosilicon compound, and MW_{H2O} is the molecular weight of water.

27. The stabilized salt-in-solvent mixture of claim 20, wherein the organosilicon compound is selected from the group consisting of:

(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and

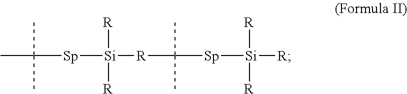

where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of:

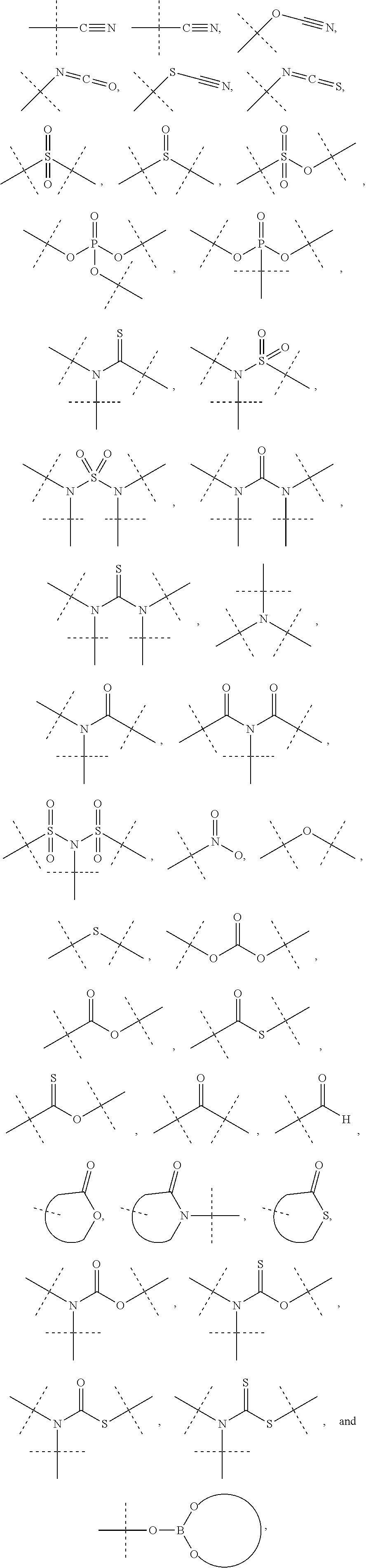

wherein a curved bond denotes a C₂₋₆ alkylene bridging moiety;
wherein the organosilicon compound inhibits degradation reactions within the salt-in-solvent mixture.

28. The stabilized salt-in-solvent mixture of claim 27, wherein the carbonate is selected from the group consisting of ethyl methyl carbonate, dimethyl carbonate, and diethyl carbonate, ethylene carbonate, propylene carbonate, and γ-butyrolactone.

The objects and advantages of the invention will appear more fully from the following detailed description of the preferred embodiment of the invention made in conjunction with the accompanying drawings.

### BRIEF DESCRIPTION OF THE DRAWINGS

FIG. 1A depicts autocatalytic HF production in salt-in-solvent-mixture (upper panel; HF is a marker for degradation) and reduction in HF production in organosilicon (OS) nitrile formulations (lower panel). A salt-in-solvent mixture with ethylene carbonate/diethyl carbonate (EC/DEC) (3/7, % v) and 1M LiPF₆ at 100° C. serves as a control. A series of solutions were prepared with addition of 100 ppm H₂O (+100 ppm) and 500 ppm H₂O (+500 ppm) and compared to no added H₂O (+0 ppm). In FIG. 1A, labels beside the curves indicate the amount of H₂O added prior to thermal storage.

FIG. 1B depicts the decomposition of LiPF₆ salt with and without added OS. The LiPF₆ salt decomposition without OS increases exponentially. With OS, the LiPF₆ salt decomposition does not increase. A salt-in-solvent mixture with EC/DEC (3/7, % v) and 1M LiPF₆ at 100° C. serves as a control. A series of solutions were prepared with addition of 100 ppm H₂O (+100 ppm) and 500 ppm H₂O (+500 ppm) and compared to no added H₂O (+0 ppm). Labels beside the curves indicate the amount of H₂O added prior to thermal storage.

FIG. 1C depicts an exemplary chemical reaction of HF removal by an OS nitrile (F1S₃MN; upper panel). The OS nitrile scavenges H⁺ to form three amide species (lower left panel) and one ether (lower right panel).

FIG. 1D depicts reduction of HF (upper panel) and formation of amides (lower panel) in a salt-in-solvent mixture comprising EC/EMC, 1M LiPF₆, and OS nitriles. A series of solutions were prepared with addition of 100 ppm H₂O (+100 ppm) and 500 ppm H₂O (+500 ppm) and compared to no added H₂O (+0 ppm). In the lower panel, labels beside the curves indicate the amount of H₂O added prior to thermal storage.

FIG. 2A depicts the 19F NMR spectrum of the OS/PF₅ complex with an exemplary OS nitrile (F1S₃MN). The composition comprises F1S₃MN and 1M LiPF₆ at 100° C. for 260 days.

FIG. 2B depicts the 19F NMR spectrum of the OS/PF₅ complex with an exemplary OS nitrile (F1S₃MN) in a carbonate blend. The composition comprises EC/F1S₃MN (2-to-8 by volume) and 1M LiPF₆ at 100° C. for 260 days.

FIG. 3A depicts HF production in a salt-in-solvent mixture comprising EC/EMC and 1M LiPF₆ at 100° C. (upper panel) and 70° C. (lower panel). HF production is visibly autocatalytic at 100° C., but not at lower temperature 70° C.

FIG. 3B depicts storage of a salt-in-solvent mixture comprising OS nitriles (F1S₃MN; DF1S₂MN) at 30° C. for 141 days. A salt-in-solvent mixture without addition of OS nitriles serves as a control. A series of solutions were prepared with addition of 500 ppm H₂O (+500 ppm) and compared to no added H₂O (nominal moisture).

FIG. 3C depicts storage of a salt-in-solvent mixture comprising OS nitriles (F1S₃MN; DF1S₂MN) at 45° C. for 141 days (upper panel). A salt-in-solvent mixture without addition of OS nitriles serves as a control. A series of solutions were prepared with addition of 500 ppm H₂O (+500 ppm) and compared to no added H₂O (nominal moisture). The lower panel table shows reduction of HF from 70 to 141 days in the control salt-in-solvent mixture and salt-in-solvent mixtures with OS nitriles.

FIGS. 4A and 4B depicts the reduction in HF production in salt-in-solvent mixture formulations containing multiple OS nitrile molecules. All OS nitriles are present at 0.13M (FIG. 4A) or 1M (FIG. 4B) in a salt-in-solvent mixture with ethylene carbonate/diethyl carbonate (EC/DEC) (3/7, % v) and 1M LiPF₆. No water was added to the salt-in-solvent mixture prior to thermal storage. For 0.13M OS (FIG. 4A) the curves for F1S₂MN and TF1S₂MN overlap such that only the TF1S₂MN curve is visible.

FIG. 5A depicts the reduction in HF production in salt-in-solvent mixture formulations containing other nitriles (succinonitrile, adiponitrile, and valeronitrile; structures of the compounds are shown on the right) compared to OS,F1S₃MN, at 100° C. A series of solutions were prepared with addition of 500 ppm H₂O (+500 ppm H₂O) and compared to no added H₂O (no H₂O).

FIG. 5B depicts decomposition of other nitriles (succinonitrile, adiponitrile, and valeronitrile) compared to OS,F1S₃MN, at 100° C. A series of solutions were prepared with addition of 500 ppm H₂O (+500 ppm H₂O) and compared to no added H₂O (no H₂O).

FIG. 6 depicts the reduction in HF production in salt-in-solvent mixture formulations containing compounds having the trifluoro structure at 100° C., including TF1S₂MN, TF-BN (trifluorobutyronitrile), and TF1S₆M (non-nitrile). Structures of the compounds are shown on the bottom.

FIG. 7A depicts HF concentrations in salt-in-solvent mixture formulations containing EC and different concentrations of OS,F1S₃MN at 100° C. (Left panel: 1% and 2% OS; right panel: 5%, 8%, 16%, 20%, and 87% OS). The EC blend has a dielectric constant of 89.

FIG. 7B depicts HF concentrations in salt-in-solvent mixture formulations containing EC/DEC (3/7) and different concentrations of OS (0%, 2%, 5%, 10%, and 16%) at 100° C. The EC/DEC blend has a dielectric constant of 21.8.

FIG. 7C depicts HF production in salt-in-solvent mixture formulations containing high salt EMC and 2.5M LiPF₆ at 100° C. The HF production with addition of 500 ppm H₂O (+500 ppm H₂O) is compared to no added H₂O (nominal moisture).

FIG. 7D depicts the reduction of HF production in salt-in-solvent mixture formulations containing high salt EMC, 2.5M LiPF₆ and different concentrations of OS at 100° C. A salt-in-solvent mixture without OS serves as a control. No water was added to the mixture prior to thermal storage.

### DETAILED DESCRIPTION OF THE INVENTION

The elements and method steps described herein can be used in any combination or order whether explicitly disclosed or not.

All combinations of method steps as used herein can be performed in any order, unless otherwise specified or clearly implied to the contrary by the context in which the referenced combination is made.

The system disclosed herein may comprise, consist of, or consist essentially of the various steps and elements disclosed herein. The disclosure provided herein suitably may be practiced in the absence of any element or step which is not specifically disclosed herein.

All references to singular characteristics or limitations of the present invention shall include the corresponding plural characteristic or limitation, and vice-versa, unless otherwise specified or clearly implied to the contrary by the context in which the reference is made. The indefinite articles “a” and “an” mean “one or more.”

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

It is understood that the compounds and compositions disclosed herein are not confined to the specific construction and arrangement of parts herein illustrated and described, but embraces such modified forms thereof as come within the scope of the claims.

### Degradation Mechanisms of Alkali Metal PF₆ Salt:

Alkali metal PF₆ salt, such as LiPF₆, is known to have at least two degradation mechanisms while being present in a carbonate-based solvent system. The first is through interaction with any amount of water that might be present in the system:

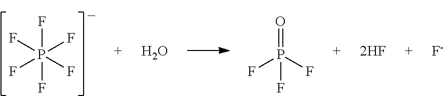

This reaction results in the formation of highly acidic hydrofluoric acid (HF) and insoluble LiF. HF can in turn catalyze the further degradation of carbonate materials, and result in the production of more HF through further degradation of the carbonate components and the resulting development of insoluble LiF.

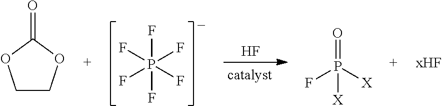

While great care is taken in the industry to keep water contamination as low as possible in LiPF₆/carbonate solutions, it is difficult and expensive to eliminate it completely.

In addition, there is a second mechanism of degradation available to LiPF₆ in carbonate systems that does not require any additional, extraneous water:

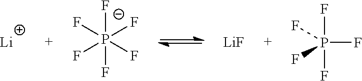

It has been determined that LiPF₆ in carbonate solutions is always in equilibrium with the LiF—PF₅ pair. This equilibrium will be driven to the right at higher temperatures. The PF₅ molecule is a very reactive gas molecule that will immediately react with the carbonate carrier material which will result in a carbonate decomposition reaction that also produces HF and is autocatalytic. Because of the autocatalysis, the carbonate decomposition reaction, once begun, only picks up speed over time.

### Scavenging H⁺ by Amines:

It must be noted that the decomposition of carbonates in the presence of PF₆⁻¹ anion leads to the production of HF, and the decomposition of carbonates in general tends to produce acidic species which catalyze further decomposition. Trapping the H⁺ is fundamental to stop that decomposition. One way in which acids can be scavenged is by reacting with amines to form an ammonium salt. The reaction between amines and acids is very well known and is an effective way of removing acidic hydrogens from a solution by trapping them into a stable salt with an N—H bond. Organosilicon amines can provide an immediate reduction in HF and other acidic compounds by trapping the H⁺ cations present in the salt-in-solvent mixtures or electrolytes.

### Mitigation of Alkali Metal PF₆ Salt Degradation by Organosilicon Compounds:

Disclosed herein is a stabilized salt-in-solvent mixture. The mixture comprises a salt, a carbonate solvent, and an organosilicon (OS) compound, wherein the OS compound suppresses, inhibits, and otherwise slows degradation reactions within the salt-in-solvent mixture. This stabilized salt-in-solvent mixture can be used for electrolyte formulations for use in Li-ion batteries.

As used herein, salt is purposefully defined broadly to include all salts, including, but not limited to lithium salts, sodium salts, potassium salts, magnesium salts, borate salts, phosphate salts, and the like. Non-limiting examples include lithium hexafluorophosphate, lithium tetrafluoroborate, lithium perchlorate, sodium hexafluorophosphate, sodium tetrafluoroborate, sodium perchlorate, potassium hexafluorophosphate, potassium tetrafluoroborate, potassium perchlorate, magnesium hexafluorophosphate, magnesium perchlorate, magnesium tetrafluoroborate, tetraethylammonium tetrafluoroborate (TEA-TFB), tetrabutylphosphonium tetrafluoroborate, tetrabutylphosphonium hexafluorophosphate, tetrabutylammonium tetrafluoroborate, tetraethylammonium hexafluorophosphate, and tetraethylammonium perchlorate.

Carbonate has been conventionally used as solvent for electrolyte compositions. Non-limiting examples of carbonate solvents include linear carbonates such as ethyl methyl carbonate (EMC), dimethyl carbonate (DMC), and diethyl carbonate (DEC); cyclic carbonates such as ethylene carbonate (EC), propylene carbonate (PC), and γ-butyrolactone; and various fluorine-containing linear or cyclic carbonates. The salt-in-solvent mixture may include carbonate solvent or carbonate solvent mixtures at a wide range of concentrations, including but not limited to, about 90 wt % to about 100 wt % of the total solvent. Examples of suitable total carbonate solvent concentrations include about 90 wt %, about 95 wt %, about 97 wt %, about 98 wt %, about 99 wt %, about 99.5 wt %, about 99.97 wt % of the total solvent, or a range between and including any of the preceding amounts.

The OS compounds used herein are described in detail in the section below. The salt-in-solvent mixture may include OS compounds at a wide range of concentrations, including but not limited to, about 0.03 wt % to about 10 wt % of the total solvent. Examples of suitable OS compound concentrations include about 0.03 wt %, about 0.5 wt %, about 1 w1%, about 2 wt %, about 3 wt %, about 5 wt %, about 10 wt % of the total solvent, or a range between and including any of the preceding amounts.

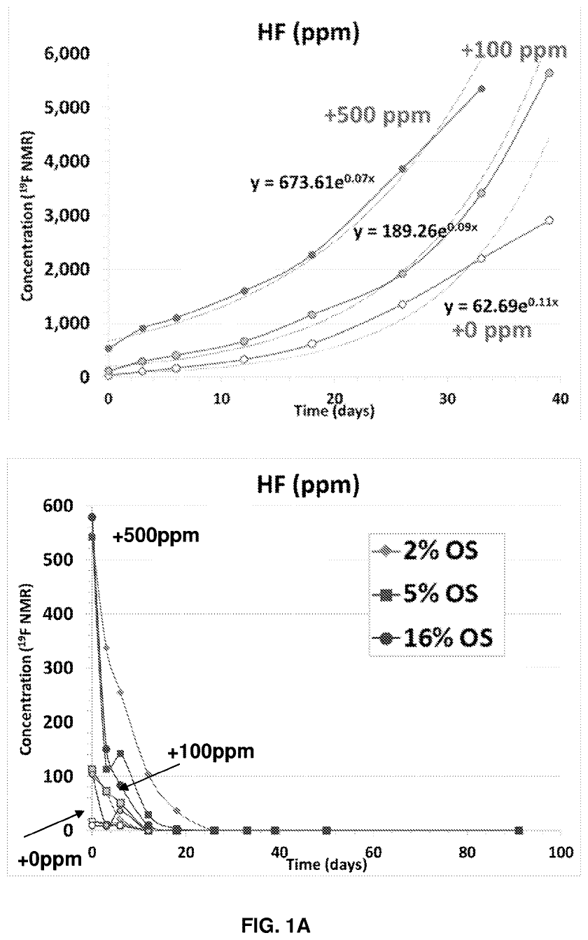

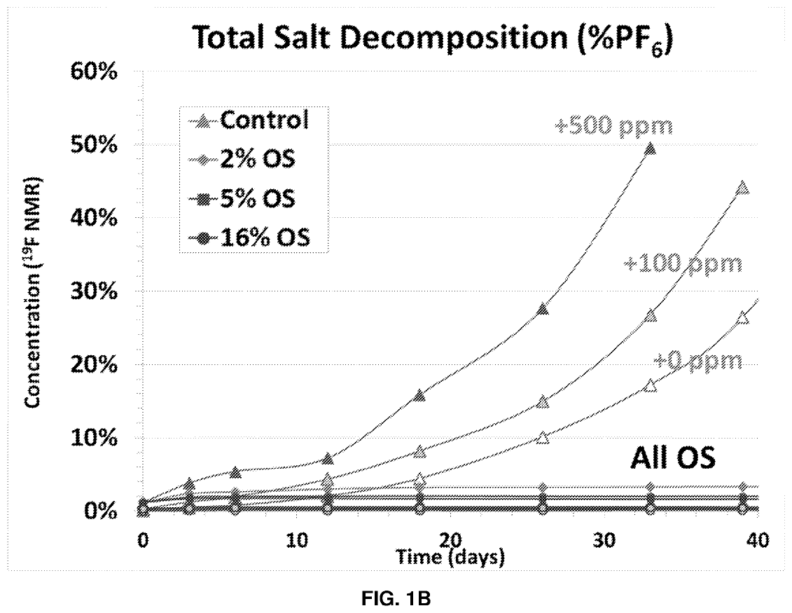

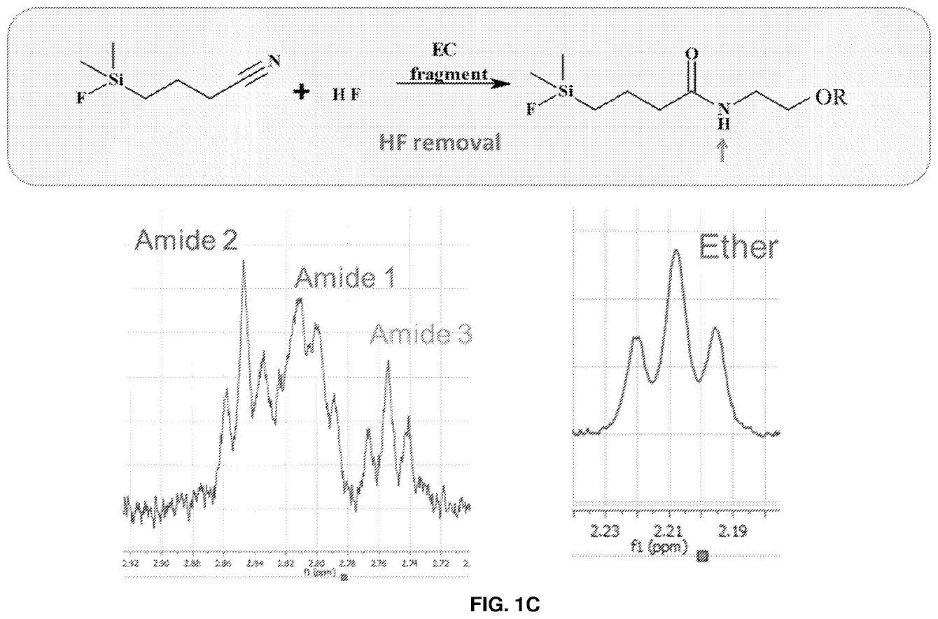

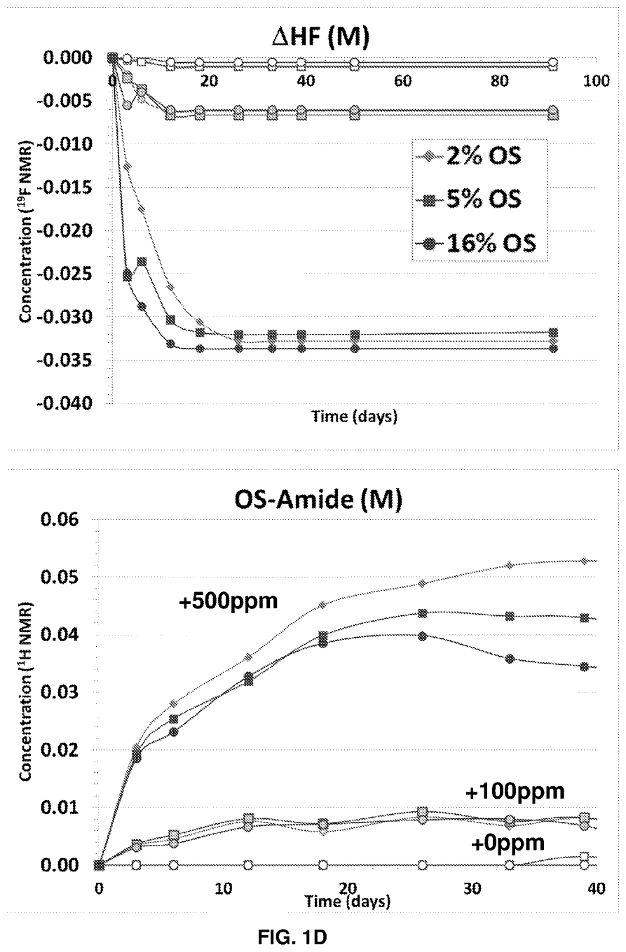

As disclosed herein, OS molecules have properties that can mitigate both forms of salt degradation outlined above. The first use case of OS based nitrile materials can be demonstrated in the case of free water that exists in the LiPF₆/carbonate system. When the water reacts with the LiPF₆, the OS nitrile molecule acts as a proton trap, reacting preferentially with the acidic component and removing it from providing further autocatalytic decomposition in its HF form. FIG. 1A shows the HF reduction observed in salt-in-solvent mixture comprising OS nitrile compared to the autocatalytic HF formation in the carbonate-based control mixture, and FIG. 1B shows suppression of the total salt decomposition in OS nitrile mixture. These are compared to the same systems with water added (+100 ppm, +500 ppm). FIGS. 1C and 1D show that the OS nitrile scavenges hydrogens into stable amide structures.

The table below shows the calculated equivalent quantity of water that can be accommodated via the stabilization of the HF formed above by the proton trap mechanism of the OS if the water is fully converted to HF (1 mol OS to 1 mol HF). Equivalent ppm H₂O based upon HF stabilized by OS in carbonate solvent is calculated using the formula:

$$Eq . ppm {H}_{2} O = ( Vol {\%}_{OS} ) * ( {density}_{OS} ) * ( \frac{1}{M {W}_{OS}} ) * ( \frac{1 mol H F}{1 mol OS} ) * ( \frac{1 mol {H}_{2} O}{2 mol H F} ) * ( M {W}_{H2O} ) * ( 1000 ) * ( \frac{1}{{density}_{solvent}} ) * ( 10 )$$

TABLE 1
The equivalent ppm H₂O based upon HF stabilized by OS in
carbonate solvent is calculated for two exemplary OS compounds
in three exemplary linear carbonate solvents.

| | | Equivalent | | Equivalent | | Equivalent | |
|---|---|---|---|---|---|---|---|
| | Volume | ppm H₂O in | | ppm H₂O in | | ppm H₂O in | |
| OS | % OS | DMC | | EMC | | DEC | |
| F1S₃MN | 0.03% | 16.1 | ppm | 17.1 | ppm | 17.6 | ppm |
| F1S₃MN | 0.05% | 26.9 | ppm | 28.6 | ppm | 29.3 | ppm |
| F1S₃MN | 0.5% | 269 | ppm | 286 | ppm | 293 | ppm |
| F1S₃MN | 1% | 537 | ppm | 571 | ppm | 587 | ppm |
| F1S₃MN | 2% | 1075 | ppm | 1143 | ppm | 1173 | ppm |
| F1S₃MN | 3% | 1612 | ppm | 1714 | ppm | 1760 | ppm |
| F1S₃MN | 5% | 2686 | ppm | 2857 | ppm | 2933 | ppm |
| F1S₃MN | 10% | 5373 | ppm | 5715 | ppm | 5866 | ppm |
| DF1S₂MN | 0.03% | 20.4 | ppm | 21.7 | ppm | 22.2 | ppm |
| DF1S₂MN | 0.05% | 33.9 | ppm | 36.1 | ppm | 37.1 | ppm |
| DF1S₂MN | 0.5% | 339 | ppm | 361 | ppm | 371 | ppm |
| DF1S₂MN | 1% | 679 | ppm | 722 | ppm | 741 | ppm |
| DF1S₂MN | 2% | 1358 | ppm | 1444 | ppm | 1482 | ppm |
| DF1S₂MN | 3% | 2036 | ppm | 2166 | ppm | 2223 | ppm |
| DF1S₂MN | 5% | 3394 | ppm | 3610 | ppm | 3706 | ppm |
| DF1S₂MN | 10% | 6788 | ppm | 7219 | ppm | 7411 | ppm |

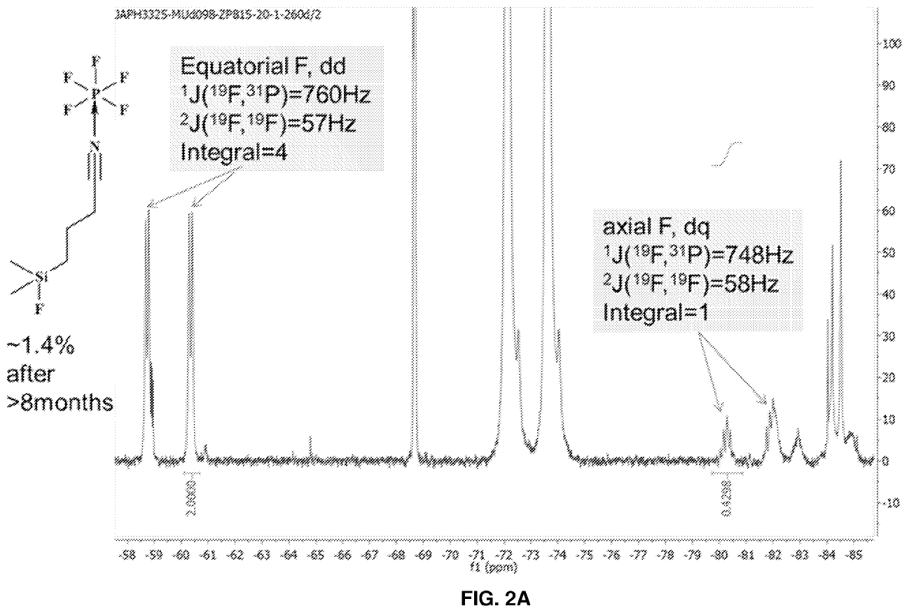

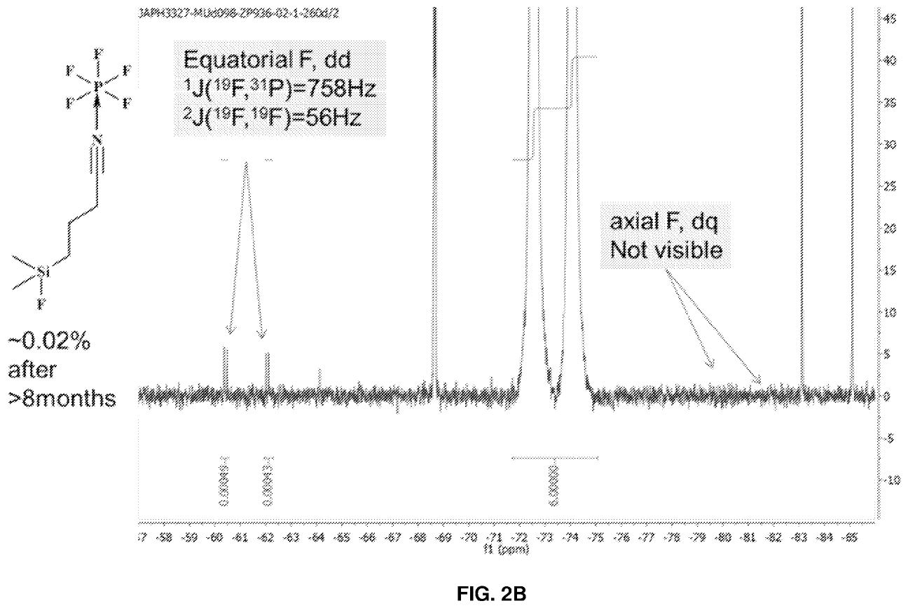

The above formula can also be used to estimate the OS concentration needed for a given amount of water impurity in the salt-in-solvent mixture.

$$( Vol {\%}_{OS} ) = \frac{[ ppm {H}_{2} O ]}{\begin{matrix}( {ρ}_{OS} ) * ( \frac{1}{M {W}_{OS}} ) * ( \frac{1 mol H F}{1 mol OS} ) * \\ ( \frac{1 mol {H}_{2} O}{2 mol H F} ) * ( M {W}_{H 2 O} ) * ( 1000 ) * ( \frac{1}{{ρ}_{sol}} ) * ( 10 )\end{matrix}}$$

Where ρ_{OS} is the density of the organosilicon compound, ρₛₒₗ is the density of the solvent mixture, MW_{OS} is the molecular weight of the organosilicon compound, MW_{H2O} is the molecular weight of water, [ppm H₂O] is the measured concentration of water in the salt-in-solvent mixture.
Further, experimental work has shown that OS nitriles are capable of complexing with PF₅ species that are generated in the equilibrium reaction, again mitigating the further decomposition of carbonate solutions through autocatalytic reactions. FIGS. 2A and 2B show the NMR spectrum of the OS/PF₅ complex with an exemplary OS nitrile (F1S₃MN).

The consequence of mitigating both the possible degradation paths results in a LiPF₆/carbonate system that is much more storage stable over time and temperature. This is true whether the system is stored in a simple container, or stored in the form of a fully assembled battery or other charge storage device.

By stopping both the degradation mechanisms described above from occurring, the method described herein enables LiPF₆/carbonate solutions (and other salt solutions) to be maintained in a purer form for longer periods of times and at higher temperatures. This is a tremendous benefit to the industry. It allows for longer-term shelf life of LiPF₆-based components while they're in the supply chain itself (pre-fabrication), thus giving suppliers more leeway in balancing their inventories for just-in-time fabrication customers. Because the goods can be stored for much longer periods without product degradation, the timely flow of product in the supply chain is greatly improved. It also improves the shelf-life of the finished products (batteries and other charge-storage devices, such as capacitors) that utilize the subject electrolyte compositions.

Thus, also disclosed herein is a method of mitigating degradation of a salt/carbonate solution for use in electrolyte formulations or in the formulated electrolytes themselves. The method comprises adding to the salt/carbonate solution an amount of organosilicon compound that inhibits degradation reactions within the salt/carbonate solution. The organosilicon compound may be added to the carbonate solvent before or after addition of the salt.

Three exemplary applications of the method and benefits of using the method are described herein:

Firstly, the production of LiPF₆ salt is a highly specialized process which is made even more difficult by the extreme reactivity of the salt, particularly with water. By introducing the salt into a highly concentrated solution with a simple carbonate solvent as soon as possible in the production process, a specific amount of OS nitrile material could also be introduced which stabilizes the solution and prevents degradation through either/both of the two mechanisms described above. This stable, LiPF₆ solution can be provided as the LiPF₆ salt component used in electrolyte formulations. The formulator would gain the benefit of having a high purity, shelf stable component that would result in a higher purity end-product of formulated electrolyte.

For example, a linear carbonate such as ethyl methyl carbonate (EMC) is often used as a solvent during the production of LiPF₆ salt. The salt-in-solvent is stored and shipped to electrolyte manufacturers, who then formulates an electrolyte by combining this LiPF₆/linear carbonate solution with other components such as cyclic carbonates and other additives to create the final battery electrolyte formulation. As defined in this disclosure, the salt-in-solvent mixture itself is not deemed a Li-ion battery electrolyte because it lacks the necessary components of a functional, commercially acceptable electrolyte. These additional materials are necessary to create suitable interfaces on Li-ion battery active materials to maximize performance of the battery. Thus, disclosed herein is a salt-in-solvent mixture comprising LiPF₆ salt, a linear carbonate such as EMC, and an OS material that suppresses degradation reactions within the salt-in-solvent mixture. With the OS added to the salt-in-solvent mixture, the shelf-life of the salt-in-solvent mixture is significantly prolonged. For example, the salt-in-solvent mixture with the OS material added can be stored for more than 6 months, and still be formulated into a commercially acceptable electrolyte for lithium-ion batteries.

The second exemplary use relates to introducing a specific amount of the OS nitrile material into the formulated electrolyte itself. Again, the stability of the now-formulated electrolyte is enhanced, allowing greater tolerance to any inadvertent moisture or inadvertent temperature storage conditions. The overall production flow of lithium batteries is improved by providing greater flexibility to the cell manufacturer in terms shelf life of the components required and the ultimate operational life of the electrolyte formulations.

A third exemplary application relates to the process of preparing salt-in-solvent and electrolyte solutions. Essentially, salt is mixed into solvent or solvent mixtures. the heat of mixing of a salt such as LiPF₆ in carbonate solvents (e.g., EMC, DMC, or DEC) is extremely high. Consequently, during the mixing process, it is possible for hotspots to be created locally. The temperature increase in these hot spot regions may stimulate the aforementioned degradation reactions. In today's electrolyte production process, great care is taken to prevent the generation of hot spots during electrolyte preparation through aggressive thermal management to remove the heat. Such mitigation measures add to the cost and complexity of electrolyte formulation. Here we disclose a novel approach to overcoming these mixing challenges. By first mixing an OS material (of the subject invention) into the carbonate solvent, prior to the salt addition, it may be possible to eliminate or reduce the temperature-induced degradation reactions.

### Organosilicon Compounds:

This disclosure includes a class of materials, i.e., organosilicon (OS) compounds that inhibit degradation pathways of electrolyte salts by interacting with the salt in either simple or complex solvent systems.

The preferred OS compound is selected from the group consisting of:

(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and

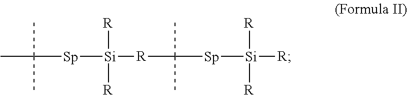

where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of an organic polar group.

In some versions of the compounds, each “Y” is independently an organic polar group selected from the group consisting of:

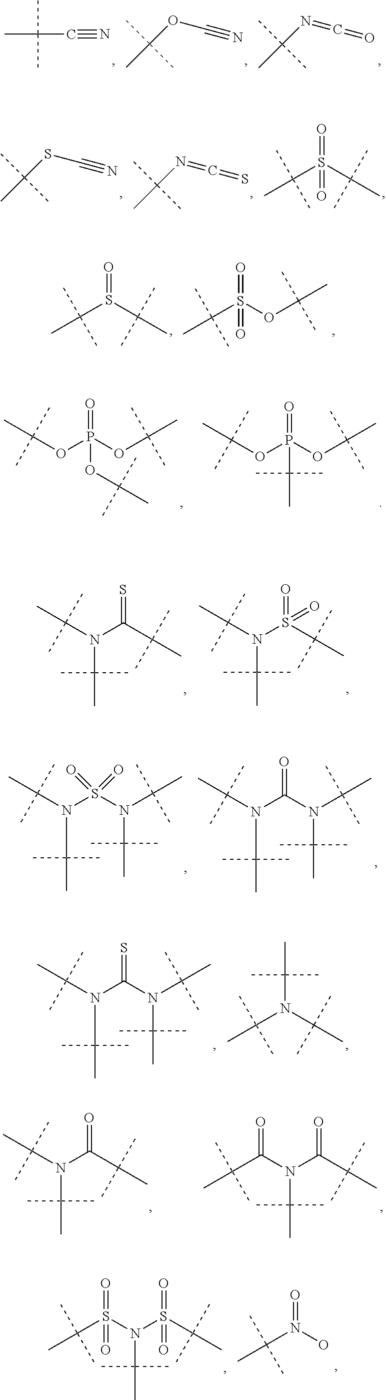

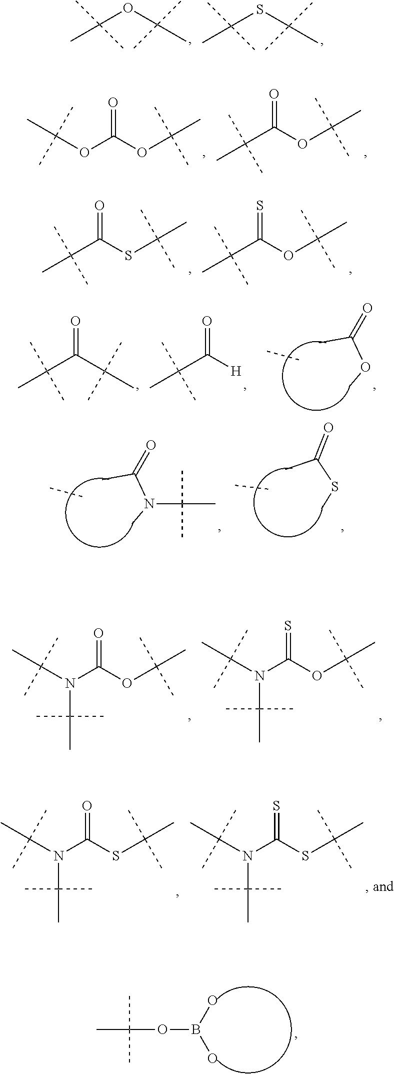

wherein a curved bond denotes a C₂₋₆ alkylene bridging moiety.

In more limited versions of the compounds, each “Y” is independently an organic polar group selected from the group consisting of:

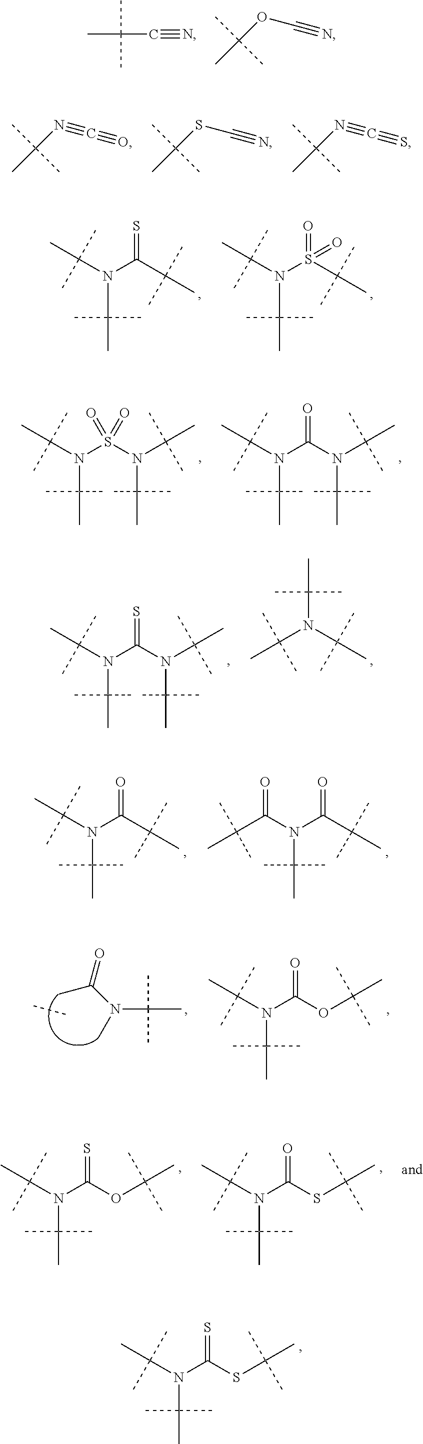

Additionally, each “Y” may optionally and independently be an organic polar group selected from the group consisting of:

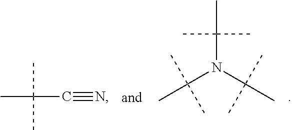

In an alternative version of the compounds, “a” is 1, and “b” is 0 to 2; optionally “b” is 1 and “Z” is R. In this version, an optional embodiment is for at least one “R” to be fluorine, and each “Sp” is independently selected from the group consisting of C₁₋₆ linear or branched alkylene which could be fluorinated.

In another alternative version of the compounds, “a” is 2, and “b” is 0 to 6; optionally “b” is 1 and “Z” is R. In this version, an optional embodiment is for at least one “R” to be fluorine, and each “Sp” is independently selected from the group consisting of C₁₋₆ linear or branched alkylene which could be fluorinated.

In yet another alternative version of the compounds, “a” is 3, and “b” is 0 to 9; optionally “b” is 1 and “Z” is R. In this version, an optional embodiment is for at least one “R” to be fluorine, and each “Sp” is independently selected from the group consisting of C₁₋₆ linear or branched alkylene which could be fluorinated.

In still another alternative version of the compounds, “a” is 4, and “b” is 0 to 12; optionally, “b” is 1 and “Z” is R. In this version, an optional embodiment is for at least one “R” to be fluorine, and each “Sp” is independently selected from the group consisting of C₁₋₆ linear or branched alkylene which could be fluorinated.

Due to the nature of the subscripts “a” and “b”, the following generic structures are explicitly within the scope of the compounds disclosed and claimed herein:

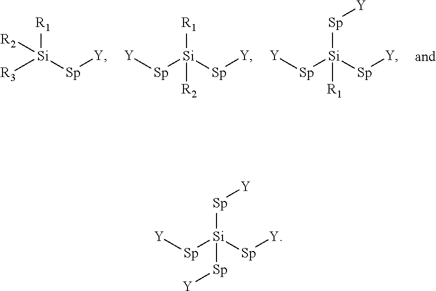

The various R groups are as defined above for “R”; Sp is as defined above, Y is as defined above.

When the polar group Y has a valency of two (2) or more it will have more than one site for substitution. Thus, there can be more than one silicon atom bonded to Y through a spacer group, as noted in the definition for Z above. Thus, the following structures are also explicitly within the scope of the compounds disclosed and claimed herein:

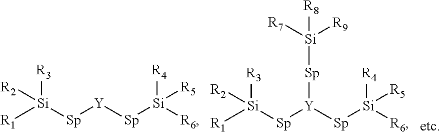

In all versions of the compounds, “halogen,” includes fluoro, chloro, bromo, and iodo. Fluoro and chloro are the preferred halogen substituents.

A subgroup of the OS compounds disclosed herein is the FnSnMN compounds that have the general formula:

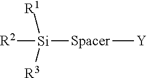

wherein R¹, R², and R³ are the same or different and are independently selected from the group consisting of C₁ to C₆ linear or branched alkyl, alkenyl, alkynyl, or halogen (preferably F), “spacer” is a C₁ to C₆ linear or branched alkylene (preferably C₁ to C₆ linear divalent alkylene). and Y is a polar organic moiety as described earlier.

The compounds disclosed herein can be made by a number of different routes. A general approach that can be used to fabricate the compounds is as follows:

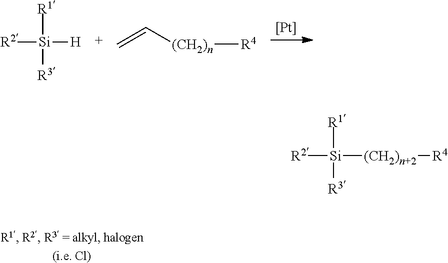

The R¹, R², and R³ groups are as defined for R herein; R⁴ has the same definition as Y; “n” is a positive integer.

The compounds disclosed herein can also be fabricated via the following approach:

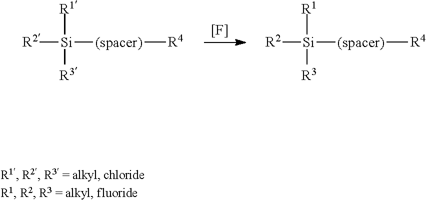

Again, the R¹, R², and R³ groups are as defined for R herein; R⁴ has the same definition as Y.

The compounds disclosed herein are also made by a number of specific routes, including the following reaction schemes:

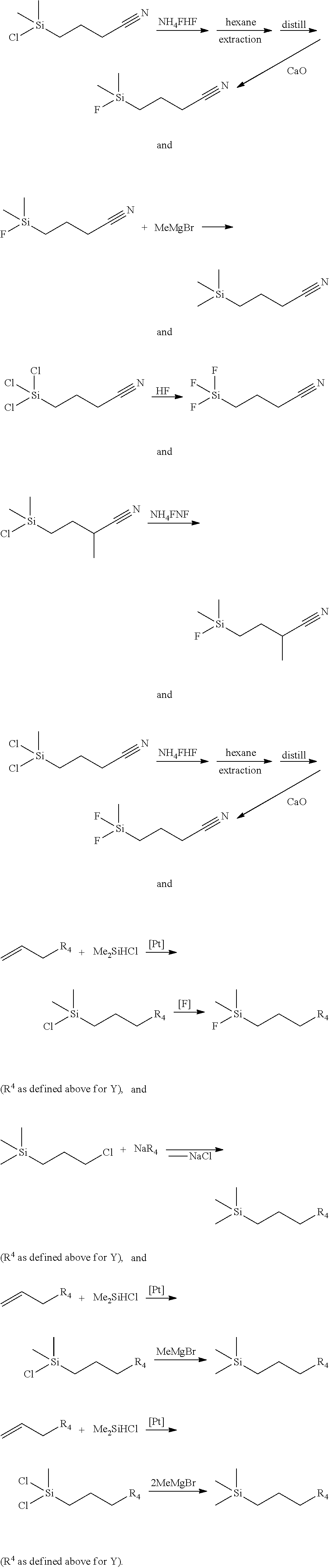

The presently disclosed compounds are organosilicon compounds having a shared structural feature in the form of a one or more terminal or internal polar organic substituents or moieties. As used herein, the term “polar organic substituent” and “polar organic moiety” are used interchangeable. The terms explicitly include, but are not limited to, the following functional groups:

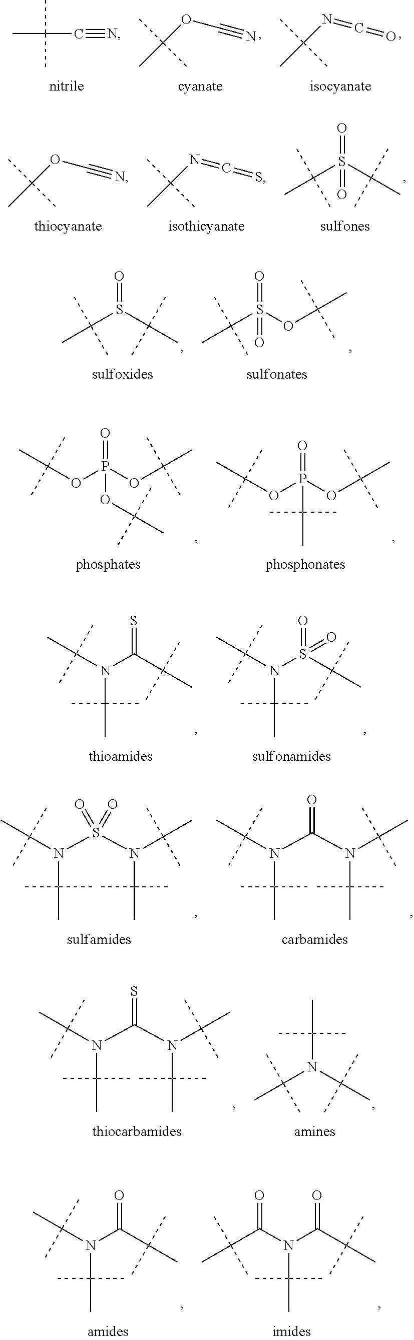

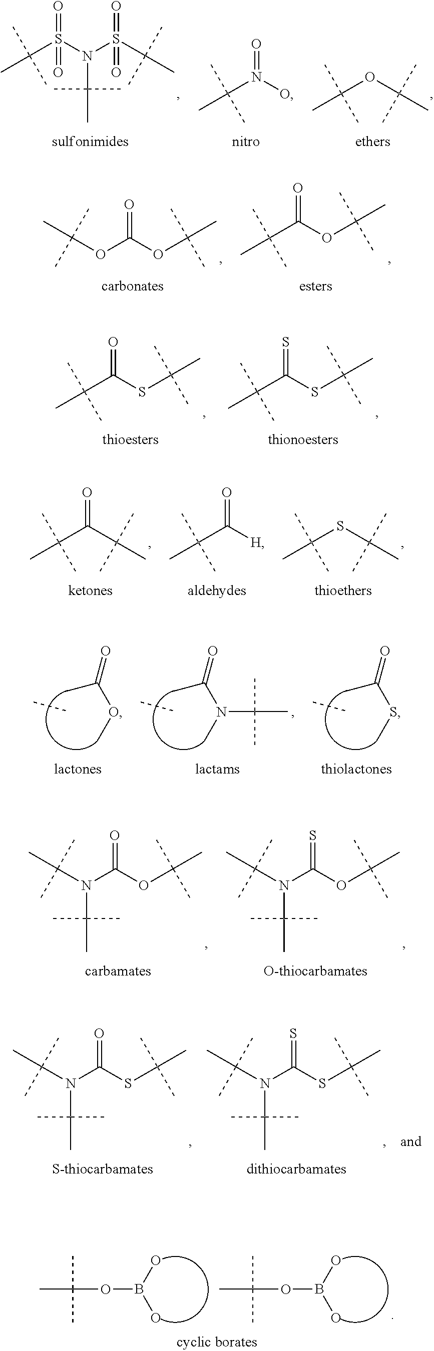

Included among the preferred compounds are the following structures:

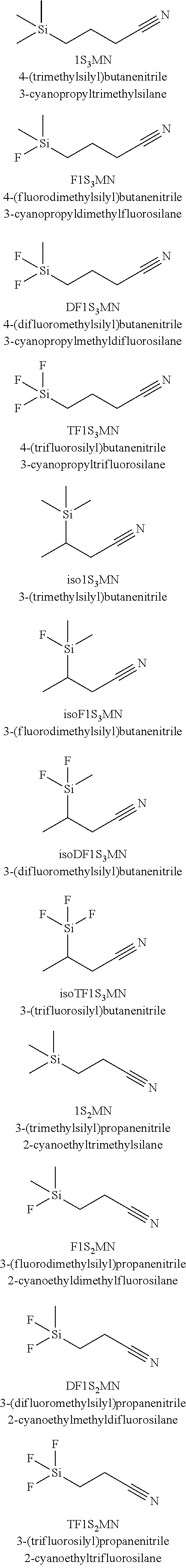

The above structures are all depicted with a terminal cyano group. This is for purposes of brevity only. The analogous compounds having internal and/or terminal polar moieties as described above in place of the cyano moiety are explicitly within the scope of the disclosure. Likewise, the halogenated compounds are depicted above as fluorinated compounds. The analogous compounds having other halogen substituents (chlorine, bromine, and/or iodine) in place of fluorine atoms are explicitly within the scope of the present disclosure. For each compound listed, two alternative systematic names are provided (the first of each pair of names designates the fundamental core as a nitrile; the second designated the fundamental cores as silane.) Additionally, each compound has been given a short-hand designation in which DF=difluoro, TF=trifluoro, and “Sn” designates the alkylene spacer between the silicon atom and the terminal cyanate, isocyanate, or thiocyanate moiety and “n” represents the number of carbon atoms in the spacer.

The synthesis of the analogous sulfones can be accomplished using the following illustrative synthesis of the compounds designated, 1NMS, F1S₃MS, and DF1S₃MS. Note that other sulfones falling within the broader disclosure contained herein can be made by the same route by simply altering accordingly the starting reagents.

The synthesis of 1NMS proceeded as follows: 2-(methylsulfonyl) ethanol was mixed with 0.5 mol equivalents of hexamethyldisilazane and about 1% mol equivalents of Al(H₂PO₄)₃ as catalyst, without solvent. The mixture was kept at about 80° C. overnight and distilled twice to get pure 1NMS.

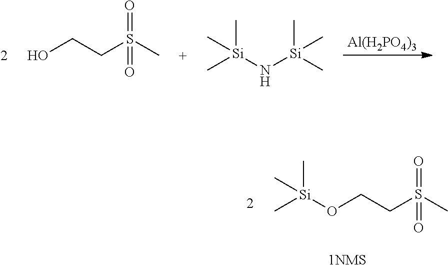

The synthesis of F1S₃MS proceeded as follows: Allylmethylsulfide was dissolved in ethanol and mixed with 4 mol equivalents of H₂O₂. Approximately 3% mol equivalents of ammonium heptamolybdate was added as catalyst for oxidation. The next day the solution was neutralized with NaHCO₃ solution and extracted with CH₂Cl₂, the water fraction was discarded, and the organic layer evaporated and distilled to yield allylmethylsulfone. Allylmethylsulfone was hydrosilylated with dimethylchlorosilane using Karstedt's catalyst. The product was fluorinated using NaFHF at about 150° C., filtered, distilled twice, and dried over a molecular sieve to yield pure F1S₃MS.

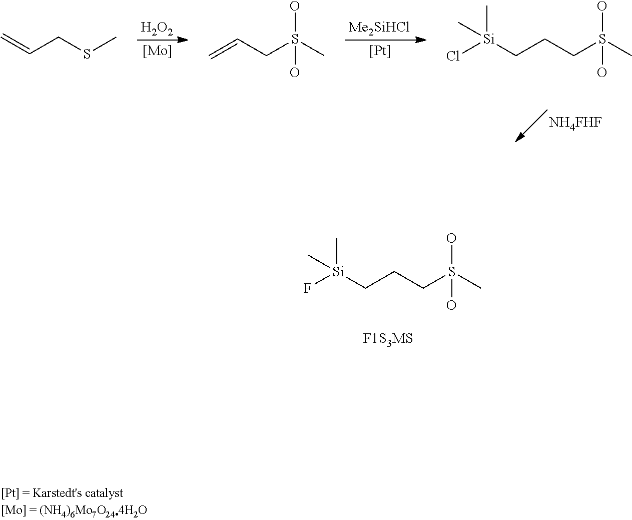

The synthesis of DF1S₃MS proceeded as follows: 3-mercaptopropylmethyldimethoxysilane was dissolved in ethanol and mixed with one (1) mol equivalent of NaOH in water. One (1) mol equivalent of Me₂SO₄ was then added to the mixture and refluxed overnight. The solid was filtered off. The crude product was oxidized with 4 mol equivalents of H₂O₂ and 3% mol equivalents of ammonium heptamolybdate. The solvent was evaporated and 2 mol equivalents of HF in water was added. The product was extracted with CH₂Cl₂ and distilled.

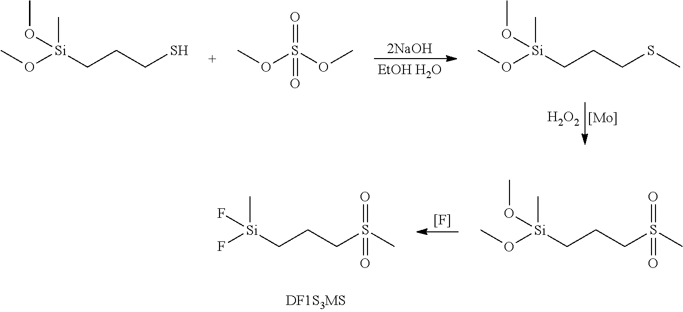

### F1S₃MN Synthesis:

Scheme 1 depicts a synthesis scheme for F1S₃MN. [F] indicates a fluorinating agent, such as HF, NH₄FHF, or other fluorinating agent. NH₄FHF is preferably used as a fluorinating agent for laboratory scale synthesis. If HF is used, the only byproduct is HCl. The synthesized F1S₃MN compound is washed from the solid salt with hexane, distilled, dried with CaO, and distilled again.

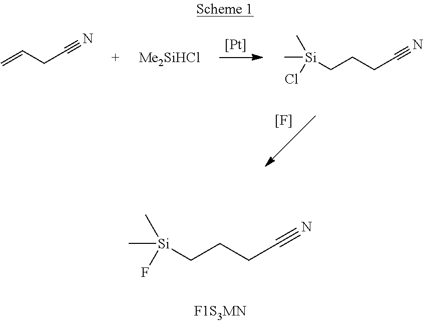

Scheme 2 depicts a synthesis scheme for F1S₃MN using NH₄FHF as a fluorinating agent. Using Karstedt's catalyst (Platinum (0)-1,3-divinyl-1,1,3,3-tetramethyldisiloxane complex solution, Cat. No. 479519, Sigma-Aldrich, St. Louis, MO), about 3% substitution on the secondary carbon occurs, generating isoF1S₃MN. The isoF1S₃MN has a lower boiling point than F1S₃MN, and most of it can be separated by fractional distillation.

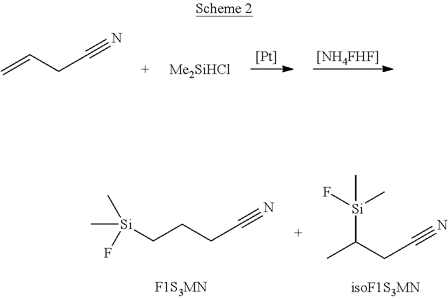

Scheme 3 depicts an alternative, shorter synthesis scheme for F1S₃MN using a Cl1S₃MN intermediate. The Cl1S₃MN intermediate can be obtained by Gelest, Inc. (Product Code SIC2452.0, 11 East Steel Road, Morrisville, PA). Use of the Cl1S₃MN intermediate reduces the time spent during synthesis.

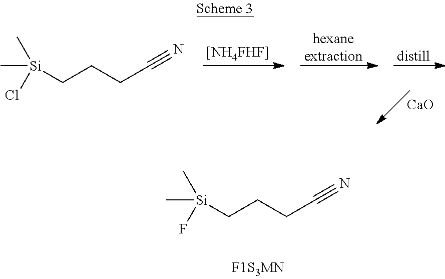

Scheme 4 depicts yet another synthesis scheme for F1S₃MN. As with Scheme 1, [F] indicates a fluorinating agent, such as HF, NH₄FHF, or other fluorinating agent. The use of HF as fluorinating agent in this synthesis scheme will not give solid byproducts, so there is no need of hexane extraction and filtration of solid. The only byproduct is HCl.

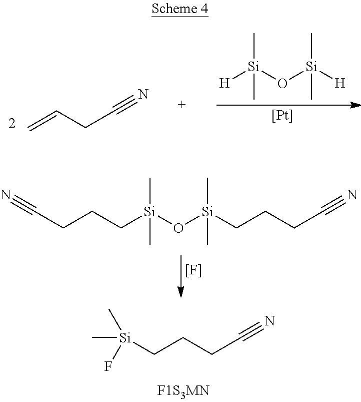

Scheme 5 depicts yet another synthesis scheme for F1S₃MN. As with Scheme 1, [F] indicates a fluorinating agent, such as HF, NH₄FHF, or other fluorinating agent.

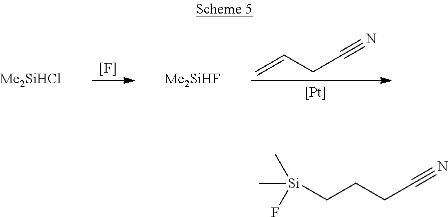

### Synthesis of F1S₃MN:

In the preferred route, allyl cyanide is heated to about 100° C. with a small amount of Karstedt's catalyst. Dimethylchlorosilane was added dropwise and refluxed 4 hours. After cooling to room temperature, the mixture was fluorinated using 1 mol equivalent of ammonium hydrogen fluoride at room temperature. Cold hexane was added to the mixture, the solid was filtered off, and the solvent evaporated. Calcium oxide was added to the crude product and it was distilled under vacuum between 45-55° C. at 0.4 Torr to yield the desired product, F1S₃MN.

### Synthesis of F1S₃ME:

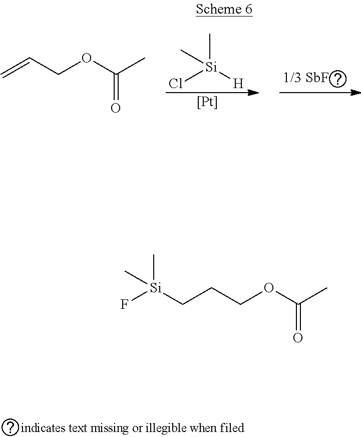

In the preferred route, allyl acetate is mixed with dimethylchlorosilane and a small amount of Karstedt's catalyst is added. The mixture is left reacting overnight. Next day, the mixture was fluorinated using 0.33 mol equivalent of antimony trifluoride at room temperature overnight with strong stirring. Next day, the solid was filtered off, and the product distilled under vacuum between 25-30° C. at 0.3 Torr to yield the desired product, F1S₃ME.

### Synthesis of DF1S₃DN:

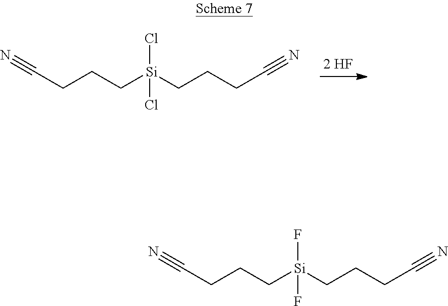 [SMILES: N#CCCC[Si](Cl)(Cl)CCCC#N ; N#CCCC[Si](F)(F)CCCC#N]

Bis(cyanopropyl)dichlorosilane was mixed with 2 mol equivalents of aqueous HF at room temperature and left reacting overnight. The crude product was extracted with dichloromethane, the solvent evaporated and the product distilled under vacuum at 165° C. at 0.1 Torr to yield the desired product, DF1S₃DN.

### Synthesis of 1S₃DN:

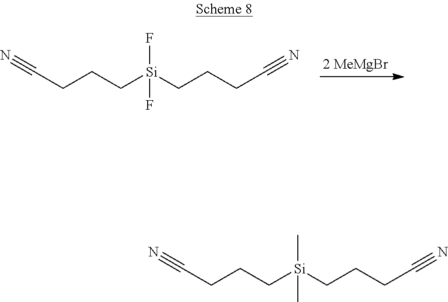

DF1S₃DN was dissolved in THF and cooled with an ice bath, then 2 mol equivalents of methylmagnesium bromide were added and the mixture was left reacting until it slowly reached room temperature. The mixture was quenched with ethanol, the crude product was extracted with dichloromethane, the solvent evaporated and the product distilled under vacuum at 125° C. at 0.2 Torr to yield the desired product, 1S₃DN.

### Synthesis of TF1S₃MN:

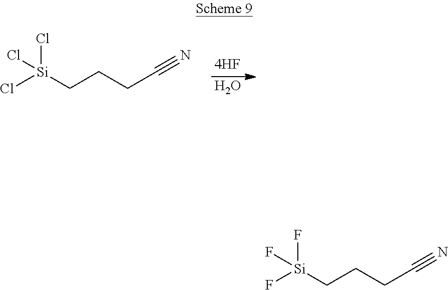

Cyanopropyltrichlorosilane was cooled in an ice bath and 4 mol equivalents of aqueous HF were added dropwise. The mixture was left reacting no more than 2 hours. The crude product was extracted with dichloromethane, the solvent evaporated and the product distilled under vacuum at 25° C. at 0.2 Torr to yield the desired product, TF1S₃MN.

### Synthesis of DPF1S₃MN:

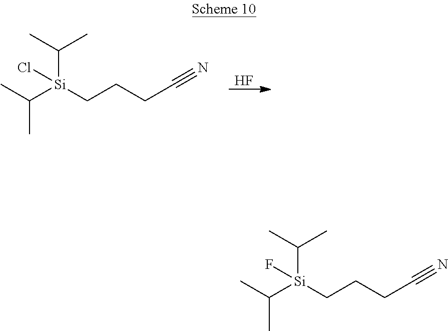

Bis(isopropyl)cyanopropylchlorosilane was dissolved in THF and cooled in an ice bath, then 1 mol equivalent of aqueous HF was added dropwise and left reacting overnight at room temperature. Next day the solvent was evaporated and the product distilled under vacuum at 60° C. at 0.2 Torr to yield the desired product, DPF1S₃MN.

### Synthesis of DF1S₃MSO:

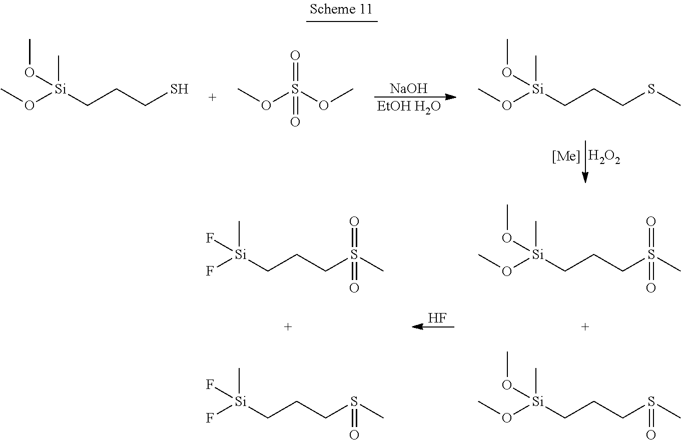

DF1S₃MSO was obtained as byproduct of incomplete oxidation during the synthesis of DF1S₃MS according to the procedure mentioned. DF1S₃MSO was purified by distillation under vacuum at 40° C. at 0.1 Torr.

### Synthesis of F1S₃MA:

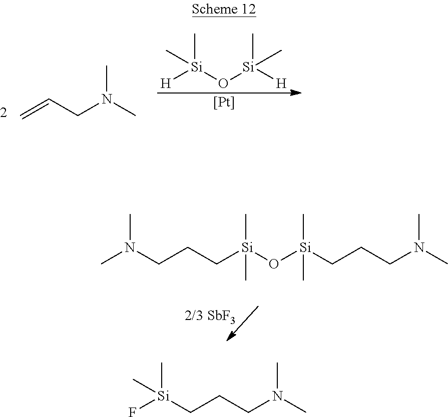

In this synthesis, 2 mol equivalents of dimethylallylamine is mixed with 1,1,3,3-tetramethyldisiloxane and a small amount of Karstedt's catalyst. The mixture is heated to 100° C. and left reacting overnight. Next day, the mixture was fluorinated using 0.67 mol equivalent of antimony trifluoride at 150° C. overnight with strong stirring. Next day, the solid was filtered off, and the product distilled under vacuum between 20-25° C. at 0.2 Torr to yield the desired product, F1S₃MA.

### Synthesis of F1S₃MC:

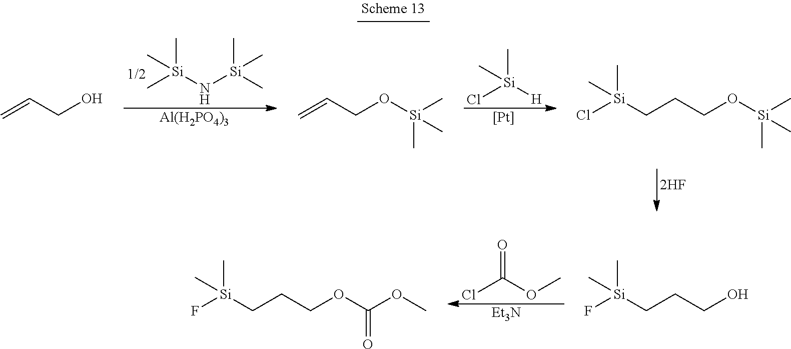

Allyl alcohol was silylated with hexamethyldisilazane, using a catalytic amount of aluminum dihydrogenphosphate at 80° C. overnight. The intermediate allyloxytrimethylsilane was distilled to purify it before the hydrosilylation. The hydrosilylation was done overnight with 1 mol equivalent of dimethylchlorosilane and a small amount of Karstedt's catalyst at 80° C. Next day, the mixture was fluorinated and hydrolyzed using 2 mol equivalent of aqueous hydrofluoric acid at room temperature with strong stirring to get the (3-hydroxypropyl)dimethylfluorosilane, which was distilled before the next step. The last intermediate was dissolved in hexane, 1 mol equivalent of trimethylamine was added, the mixture cooled in an ice bath and methyl chloroformate was added dropwise to the mixture, then it was left reacting overnight at room temperature. Next day the solid was filtered off, the solvent evaporated and the product distilled under vacuum between 28° C. at 0.2 Torr to yield the desired product, F1S₃MC.

### Synthesis of DF1S₃MN:

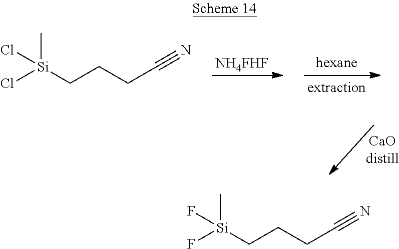

Commercial 3-cyanopropyldichloromethylsilane (CAS No. 1190-16-5; Sigma Aldrich, St. Louis, MO, US) was fluorinated with ammonium bifluoride at room temperature. Cold hexane was then added to the mixture. The solid was filtered off and the solvent evaporated. Calcium oxide was added to the crude product. The solvent was distilled under vacuum between 35-45° C. at 0.4 Torr to yield the desired product in very high purity (˜99.8%) and approximately 90% yield.

### Synthesis of DF1S₂MN:

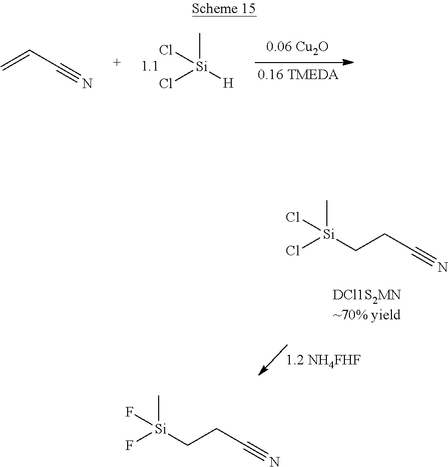

Acrylonitrile was mixed with N,N,N′,N′-tetramethylethylenediamine and copper (I) oxide in a flask and heated to 60° C. Dichloromethylsilane was then added dropwise and refluxed overnight. After cooling to room temperature, the mixture was distilled under vacuum (43° C., 0.2 Torr) to yield the dichloro intermediate (DCl1S₂MN). The intermediate was fluorinated using 1.2 mol equivalents of ammonium hydrogen fluoride at room temperature or 1.2 mol equivalents of sodium hydrogen fluoride at 130° C. Dichloromethane was then added and the solid filtered off. The solvent was evaporated and the crude product was distilled under vacuum. Triethylamine and molecular sieves were added to the product and distilled under vacuum between 25-33° C. at 0.1 Torr to yield the desired product at extremely high purity (>99%) at approximately 75% yield.

### 1ND1N Synthesis:

Scheme 16 depicts a synthesis scheme for 1ND1N. 1ND1N cannot be chemically dried with sodium (Na), calcium oxide (CaO), or calcium hydride (CaH₂).

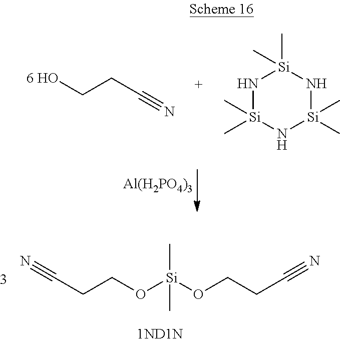

### EXAMPLES

### Effects of Temperature:

FIG. 1A shows reduction in HF production in salt-in-solvent mixture comprising OS nitrile compared to the autocatalytic HF formation in the carbonate-based control mixture without OS nitrile at 100° C. With the OS moieties, the HF concentration as close to zero after 20 days of storage at 100° C. HF production and scavenging at lower temperatures was examined.

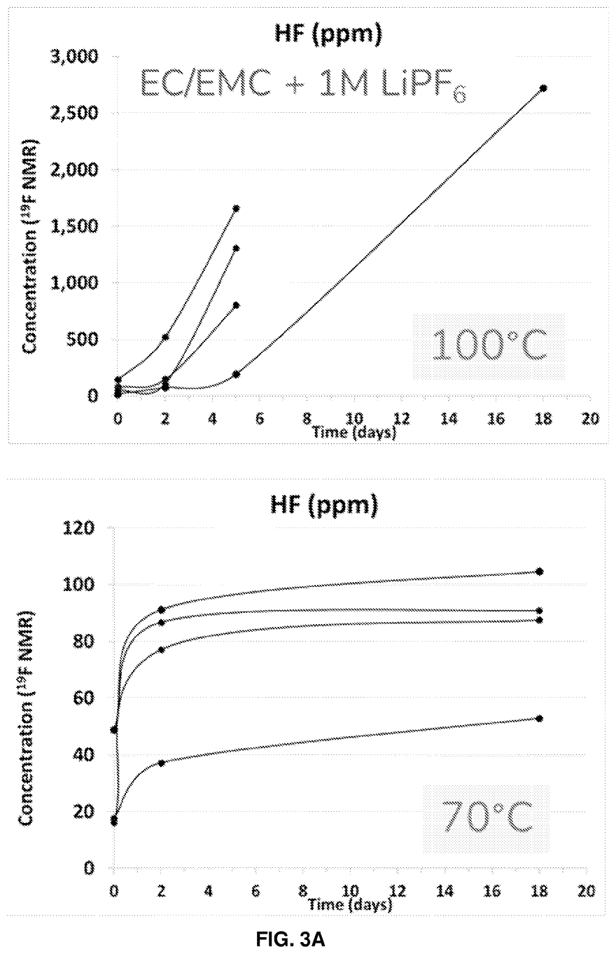

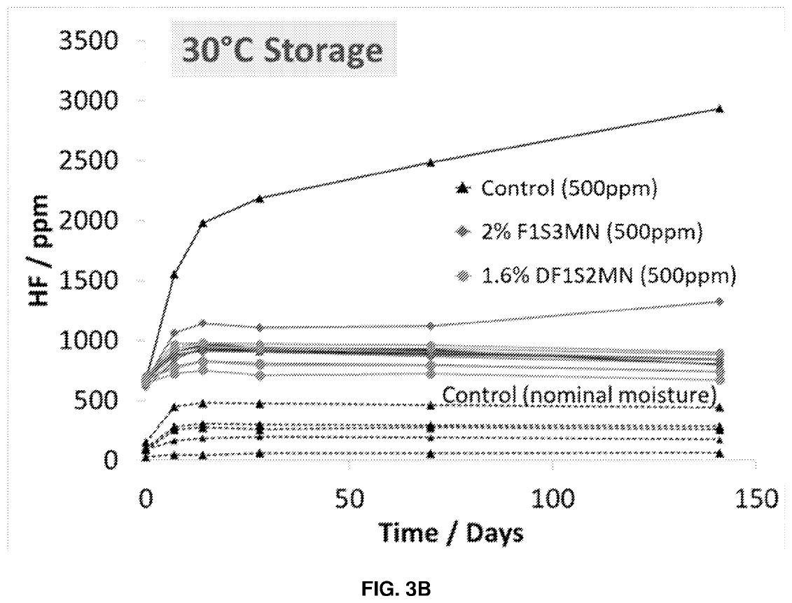

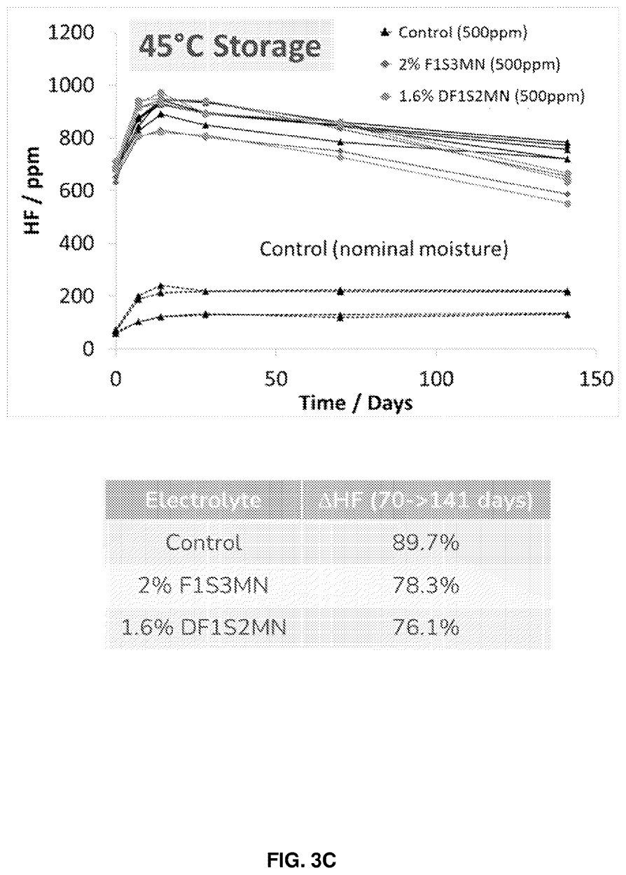

As shown in FIG. 3A, HF production is not visibly autocatalytic at 70° C. Kinetic modeling indicates that the rate constant of HF production is about 4× lower at 70° C. than 100° C.

The storage stability of the OS nitrile-containing salt-in-solvent mixture was then tested at lower temperatures compared to electrolytes without OS nitrile. When the OS nitrile electrolytes comprising F1S₃MN or DF1S₂MN were stored at 30° C., no visible H⁺ scavenging was observed after 140 days (FIG. 3B). When the OS nitrile containing salt-in-solvent mixtures comprising F1S₃MN or DF1S₂MN were stored at 45° C., no visible H⁺ scavenging was observed up through 70 days (FIG. 3C). However, after 141 days, some H⁺ scavenging was visible with the salt-in-solvent mixtures comprising OS nitriles, although all mixtures with 500 ppm added H₂O showed HF reduction (FIG. 3C).

### Effects of Compound Structure:

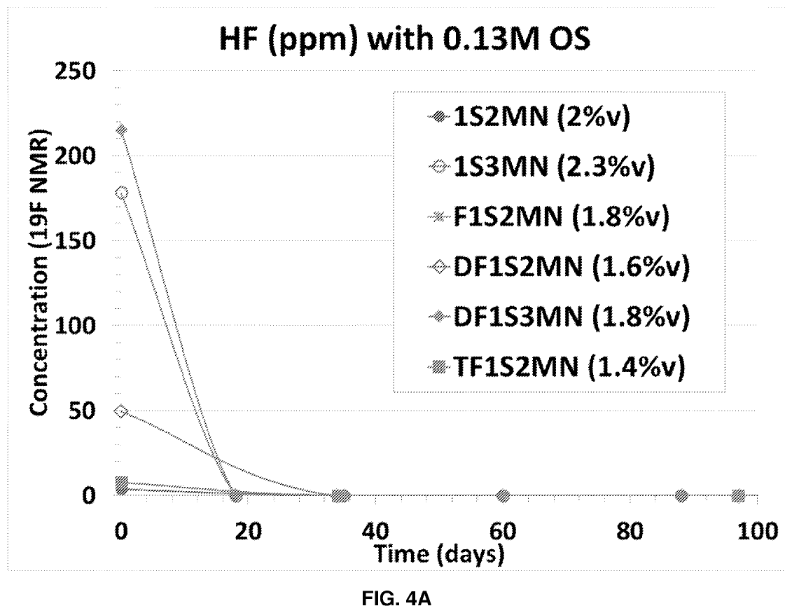

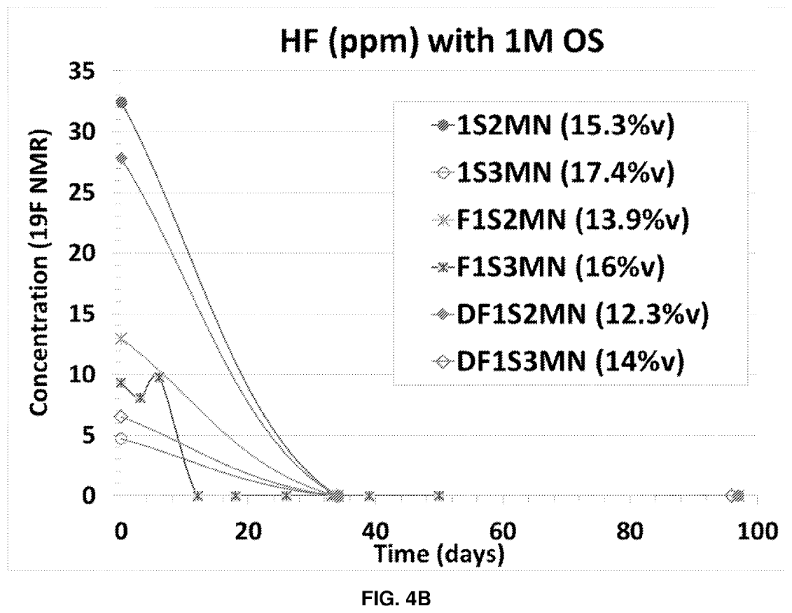

The effects of OS nitriles other than F1S₃MN on H⁺ scavenging was also tested. The tested compounds include 1S₂MN, 1S₃MN, F1S₂MN, DF1S₂MN, DF1S₃MN, and TF1S₂MN, and the results are compared to F1S₃MN. FIGS. 4A and 4B show that all the tested OS nitriles scavenge H⁺ at 100° C.

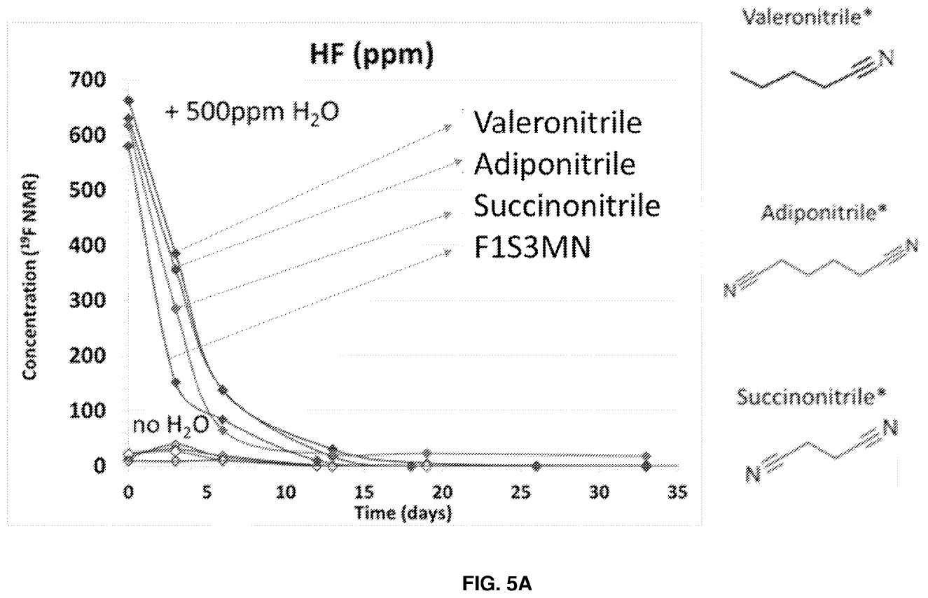

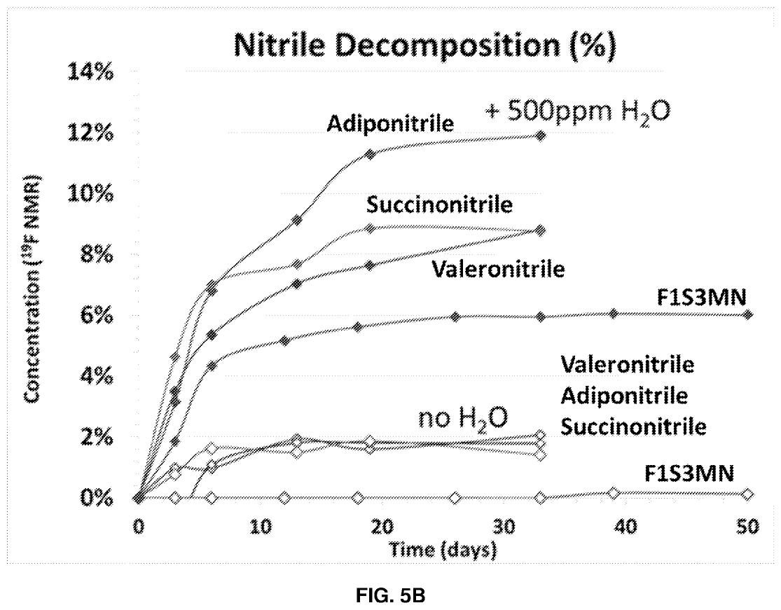

Scavenging of H⁺ by OS nitriles was also compared with other nitriles, including succinonitrile, adiponitrile, and valeronitrile. The results indicate that other nitriles scavenge H⁺ at 100° C. (FIG. 5A), but are less stable and have greater decomposition compared to the OS nitrile F1S₃MN (FIG. 5B).

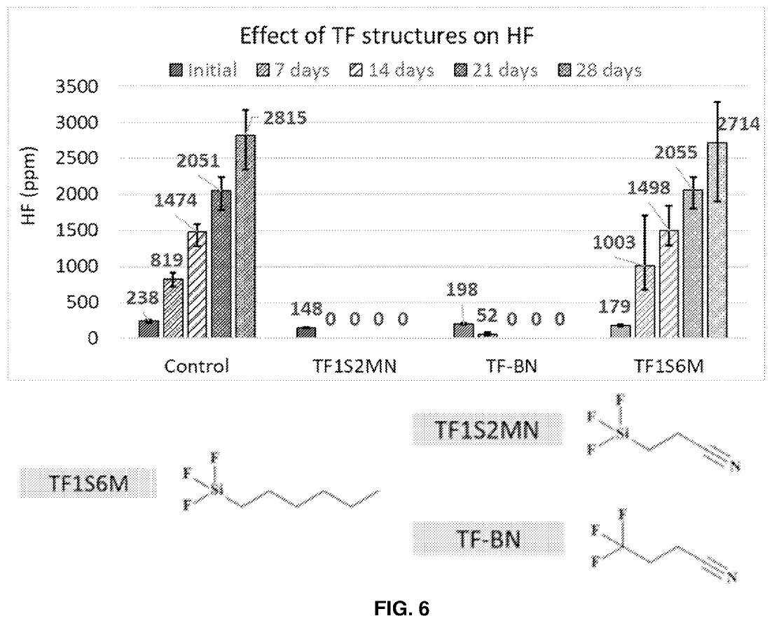

Further, the effects of the trifluoro structure on H⁺ scavenging was evaluated. Specifically, nitrile and non-nitrile compounds with a trifluoro structure were examined, including TF1S₂MN, TF-BN, and TF1S₆M (non-nitrile) (FIG. 6). The results indicate that nitriles with the trifluoro structure all scavenge H⁺ at 100° C., but the non-nitrile compound, TF1S₆M, does not scavenge H⁺ (FIG. 6).

### Effects of Carbonate Blend:

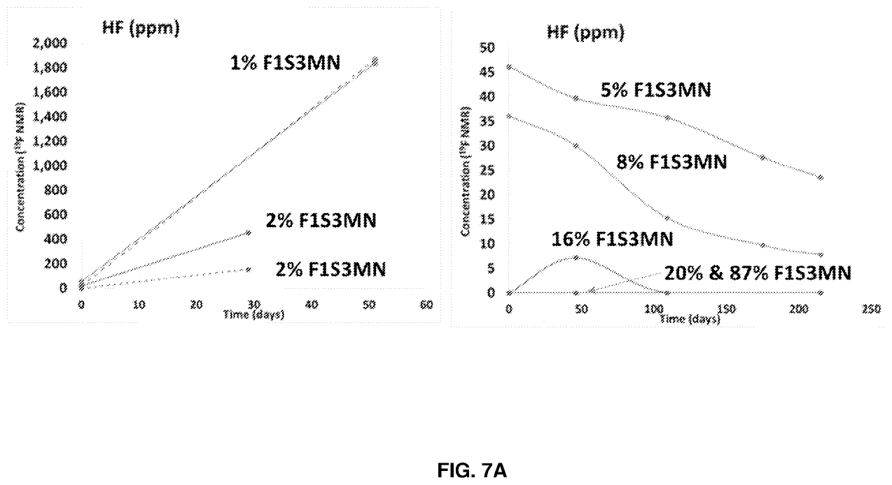

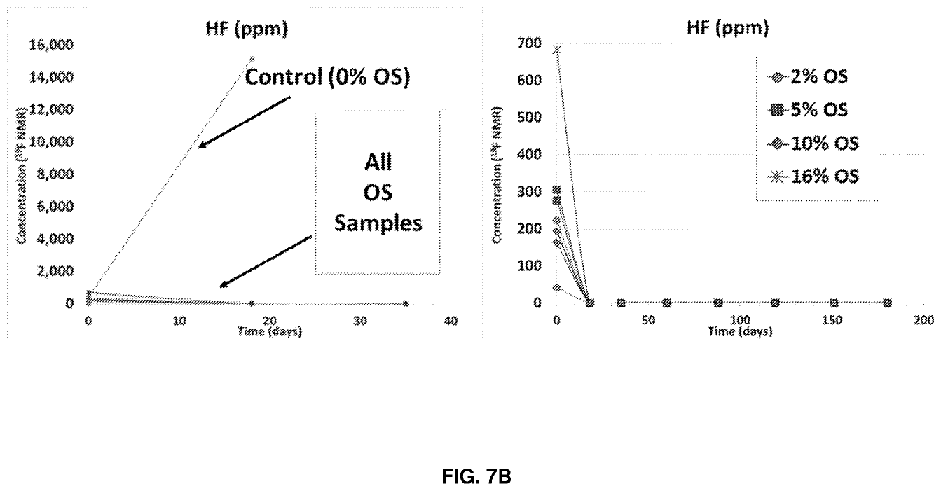

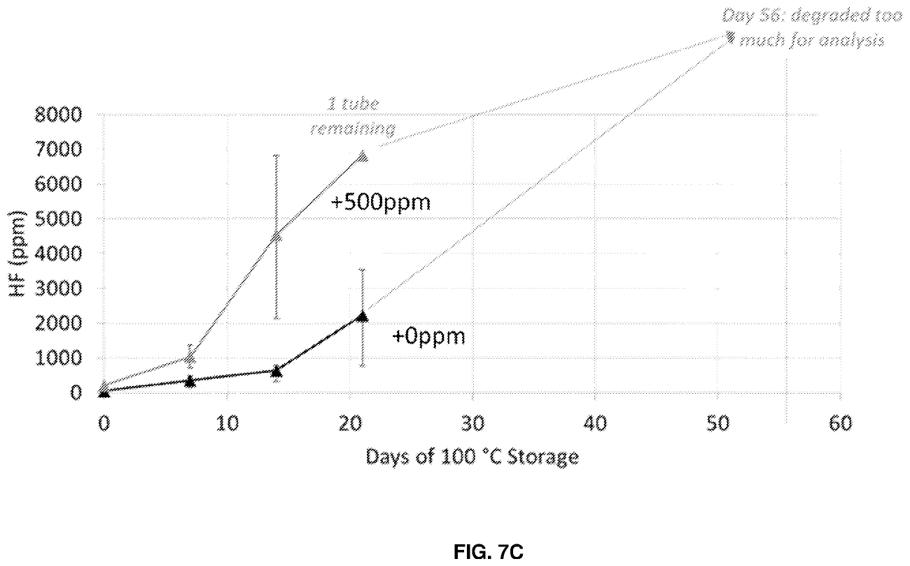

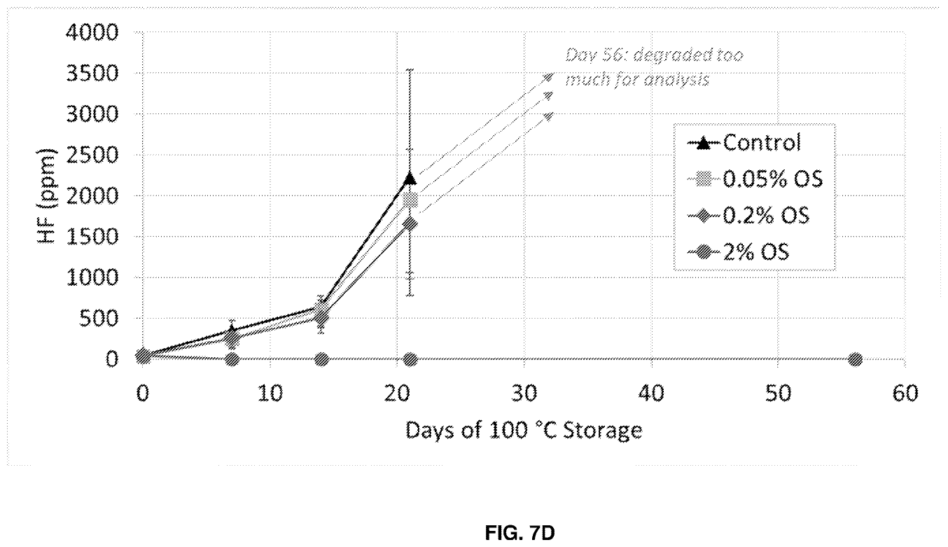

In this example, the effects of carbonate blend on the H⁺ scavenging of OS nitriles were examined. In EC blends having a dielectric constant of 89, H⁺ scavenging is dependent on the concentration of F1S₃MN. At 1-2% of F1S₃MN, no scavenging of H⁺ was observed, while higher concentrations of F1S₃MN showed increased scavenging of H⁺ (FIG. 7A). Similar results were obtained with an EC/PC blend having a dielectric constant of 76.9 (data not shown).

An EC/DEC blend having a dielectric constant of 21.8 was next investigated. The results indicate that with the EC/DEC blend having much lower dielectric constant than EC or EC/PC, the absence of OS resulted in rapid increase in HF concentration; however, with the addition of OS, the HF concentration was significantly reduced (FIG. 7B).

For high-salt EMC mixtures, when no OS nitriles were added, the concentration of HF increased significantly with storage at 100° C. for both nominal and 500 ppm added water control samples (FIG. 7C). After 56 days, the samples were too degraded for NMR analysis. In contrast, adding OS scavenges H⁺, at a F1S₃MN concentration of about 2% (FIG. 7D). A similar study was conducted with the high-salt EMC mixture and DF1S₂MN, and the minimum DF1S₂MN required to gain the same effect 1.6% (data not shown).

### Inhibition of HF Production:

Taken together, the data clearly show that the composition and method disclosed herein are highly effective at inhibiting the production of unwanted HF in salt-in-solvent mixtures comprising fluorinated salts, such as alkali metal PF₆ salts. Notably, see FIG. 1A. the control trace, without an OS present shows HF concentrations ranging from 800-1400 ppm. FIG. 1B, though, which records the results for mixtures containing from 2 to 10% OS shows no visible HF on the scale of the plot (0-20 ppm). Similarly, see FIG. 3A at top. The control trace, without OS, shows HF concentrations ranging from 800 to 2700 ppm at failure (5-18 days).

Likewise, see FIGS. 4A and 4B. FIG. 4A shows the results for a mixture containing 0.13M OS; it showed no visible HF on the scale of the plot (0-10 ppm). FIG. 4B shows the results for a mixture containing 1M OS. It had no visible HF on the scale of the plot (0-1 ppm) over the course of a month.

See also FIG. 5A, which shows the results for mixtures containing nitrile- and non-nitrile OS's. All of the mixtures showed no visible HF on the scale of the plot (0-20 ppm).

FIG. 5B is also notable because it clearly shows that the fluorinated OS nitrile compounds disclosed herein are far superior at stabilizing these types of salt-in-carbonate mixtures. FIG. 5B compares nitrile decomposition using several non-OS nitrile compounds (i.e., adiponitrile, succinonitrile, and valeronitrile) versus F1S₃MN, both in the presence and absence of water. In both situations (500 ppm water) and no water, the F1S₃MN OS was superior at inhibiting degradation of the mixture.

FIG. 6 shows the results for controls with no OS. These mixtures had HF concentrations>2000 ppm at 21 days. In stark contrast, the mixtures containing a trifluoro OS nitrile compound showed zero HF.

FIG. 7A shows that the inhibition of the formation of HF is dependent on the concentration of the OS: 1% OS had 1800 ppm HF at 50 days; 2% OS had 200-400 ppm HF at 1 month; 5% OS had 40 ppm HF at 50 days; 8% OS had 30 ppm HF at 50 days; 16% OS had 7 ppm HF at 50 days; 20% and 87% OS showed no visible HF on the scale of the plot (0-1 ppm) at 50 days. As shown in FIG. 7B, the control trace with no OS had an HF concentration>4000 ppm before 20 days. All OS samples (2%, 5%, 10%, 16%), in contrast, showed no visible HF (0-20 ppm) at 20 days. FIG. 7C shows a control with high salt concentration; the HF concentration was 2000 ppm after 20 days. FIG. 7D presents the results for high salt concentration mixtures. The control, 0.05% OS, and 0.2% OS mixtures all had HF concentrations>1500 ppm at 21 days. In contrast, the mixture with 2% OS showed no visible HF (0-100 ppm).

These results clearly show that the mixtures disclosed and claimed herein at effective at stabilizing salt-in-solvent mixtures a salt, a carbonate solvent; and an organosilicon compound.

1. A stabilized salt-in-solvent mixture, the mixture comprising a salt, a carbonate solvent; and an organosilicon compound, wherein the organosilicon compound inhibits degradation reactions within the salt-in-solvent mixture.

2. The stabilized salt-in-solvent mixture of claim 1, wherein the salt is an alkali metal PF₆ salt.

3. The stabilized salt-in-solvent mixture of claim 2, wherein the salt is selected from the group consisting of LiPF₆ and NaPF₆.

4. The stabilized salt-in-solvent mixture of claim 2, wherein the carbonate is a linear carbonate.

5. The stabilized salt-in-solvent mixture of claim 2, wherein the carbonate is selected from the group consisting of ethyl methyl carbonate, dimethyl carbonate, and diethyl carbonate, ethylene carbonate, propylene carbonate, and γ-butyrolactone.

6. The stabilized salt-in-solvent mixture of claim 2, wherein the organosilicon compound is selected from the group consisting of:
(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and 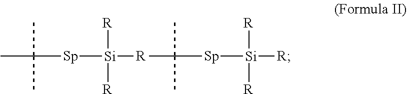
where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of an organic polar group.

7. The stabilized salt-in-solvent mixture of claim 6, wherein each “Y” is independently an organic polar group selected from the group consisting of: 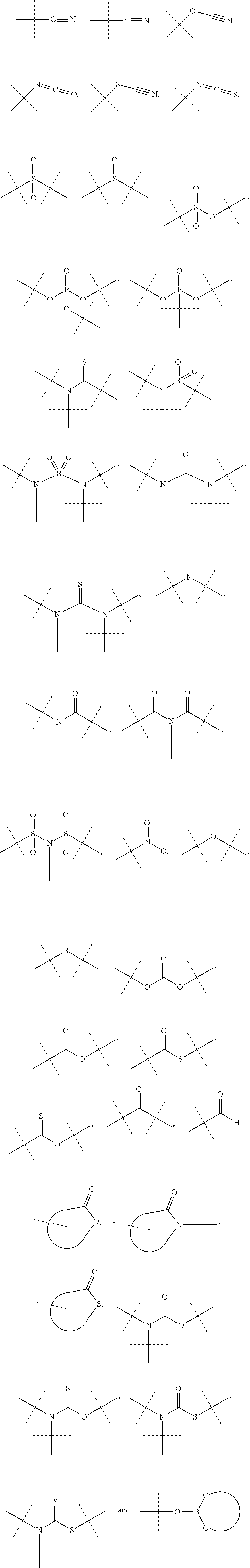
wherein a curved bond denotes a C₂₋₆ alkylene bridging moiety.

8. The stabilized salt-in-solvent mixture of claim 7, wherein each “Y” is independently an organic polar group selected from the group consisting of:

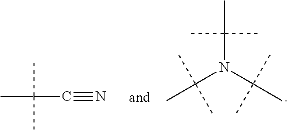

9. The stabilized salt-in-solvent mixture of claim 2, wherein the organosilicon compound is:

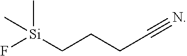

10. The stabilized salt-in-solvent mixture of claim 2, wherein the organosilicon compound is:

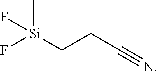

11. The stabilized salt-in-solvent mixture of claim 1 for use in electrolyte formulation.

12. A stabilized salt-in-solvent mixture, the mixture comprising an alkali metal PF₆ salt, a carbonate solvent; and an organosilicon compound selected from the group consisting of:
(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and 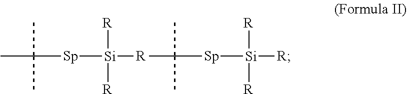
where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of: 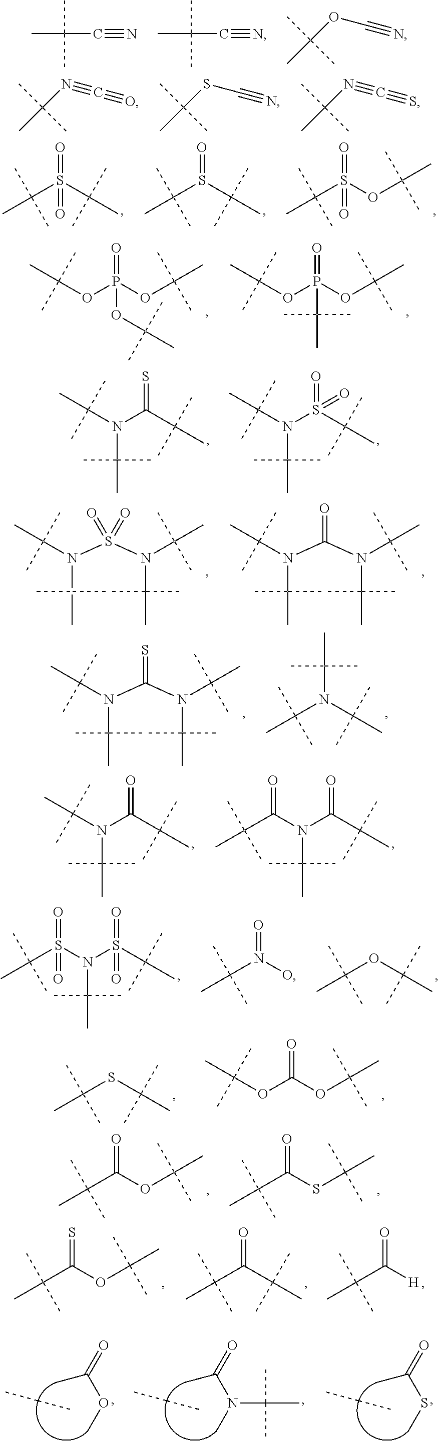 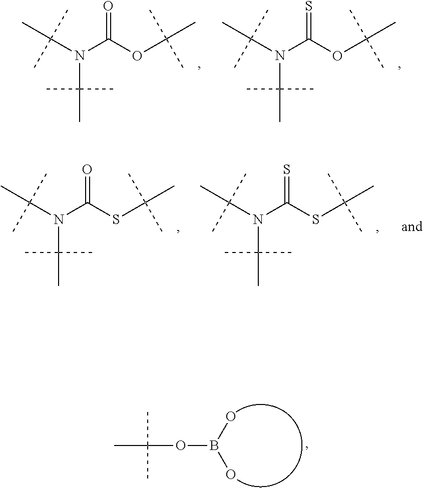
wherein a curved bond denotes a C₂₋₆ alkylene bridging moiety;
wherein the organosilicon compound inhibits degradation reactions within the salt-in-solvent mixture.

13. The stabilized salt-in-solvent mixture of claim 12, wherein the carbonate is selected from the group consisting of ethyl methyl carbonate, dimethyl carbonate, and diethyl carbonate, ethylene carbonate, propylene carbonate, and γ-butyrolactone.

14. The stabilized salt-in-solvent mixture of claim 12, wherein each “Y” is independently an organic polar group selected from the group consisting of:

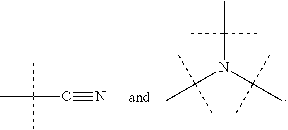

15. The stabilized salt-in-solvent mixture of claim 12, wherein the organosilicon compound is:

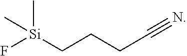

16. The stabilized salt-in-solvent mixture of claim 12, wherein the organosilicon compound is:

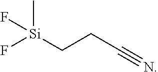

17. The stabilized salt-in-solvent mixture of claim 12, wherein the salt is selected from the group consisting of LiPF₆ and NaPF₆.

18. The stabilized salt-in-solvent mixture of claim 12 for use in electrolyte formulation.

19. A method of mitigating degradation of a salt/carbonate solution for use in electrolyte formulation or in a formulated electrolyte, the method comprising adding to the salt/carbonate solution an amount of an organosilicon compound selected from the group consisting of:
(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and 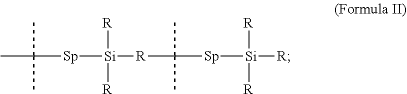
where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of: 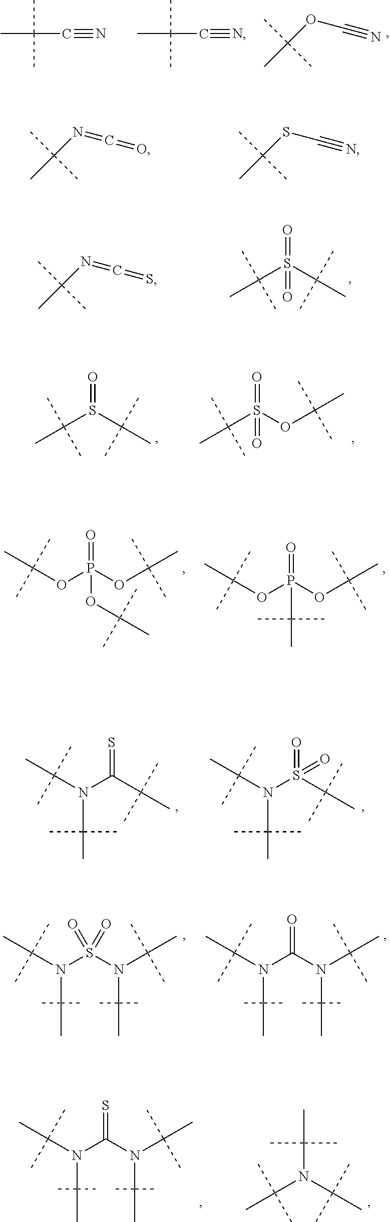 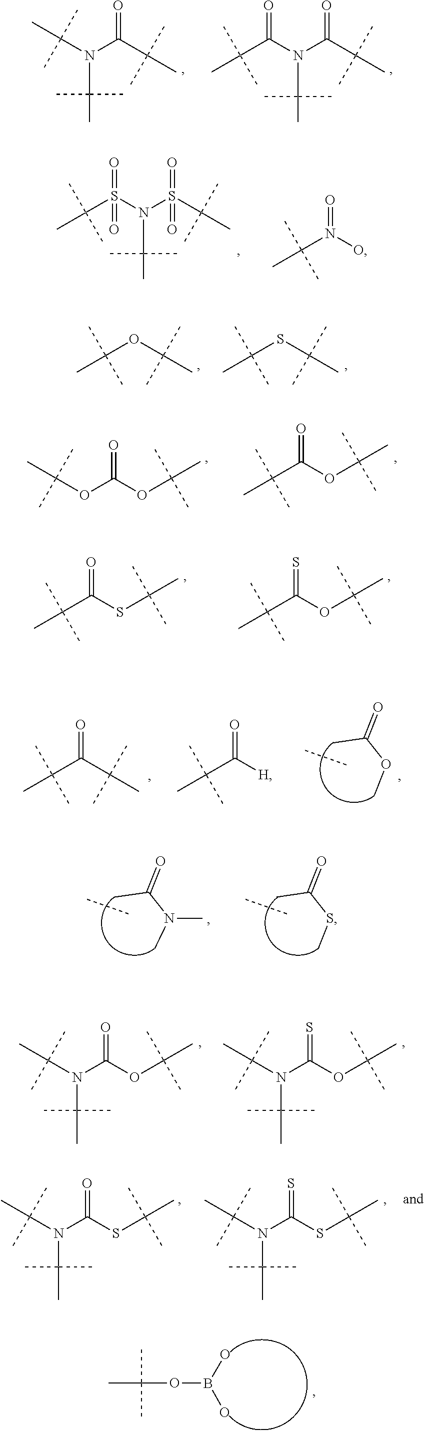
wherein a curved bond denotes a C₂₋₆ alkylene bridging moiety;
wherein the organosilicon compound inhibits degradation reactions within the salt-in-solvent mixture.

20. A stabilized salt-in-solvent mixture, the mixture comprising an alkali metal PF₆ salt, a carbonate solvent; and an organosilicon compound, wherein hydrofluoric acid (HF) concentration in the mixture is less than about 100 ppm after 20 days of storage at 100° C.

21. The stabilized salt-in-solvent mixture of claim 20, wherein hydrofluoric acid (HF) concentration in the mixture is less than about 20 ppm after 20 days of storage at 100° C.

22. The stabilized salt-in-solvent mixture of claim 20, wherein hydrofluoric acid (HF) concentration in the mixture is less than about 10 ppm after 20 days of storage at 100° C.

23. The stabilized salt-in-solvent mixture of claim 20, wherein hydrofluoric acid (HF) concentration in the mixture is less than about 5 ppm after 20 days of storage at 100° C.

24. The stabilized salt-in-solvent mixture of claim 20, wherein the organosilicon compound is selected from the group consisting of:
(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and 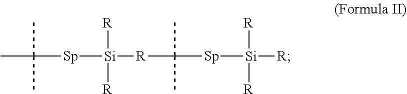
where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of: 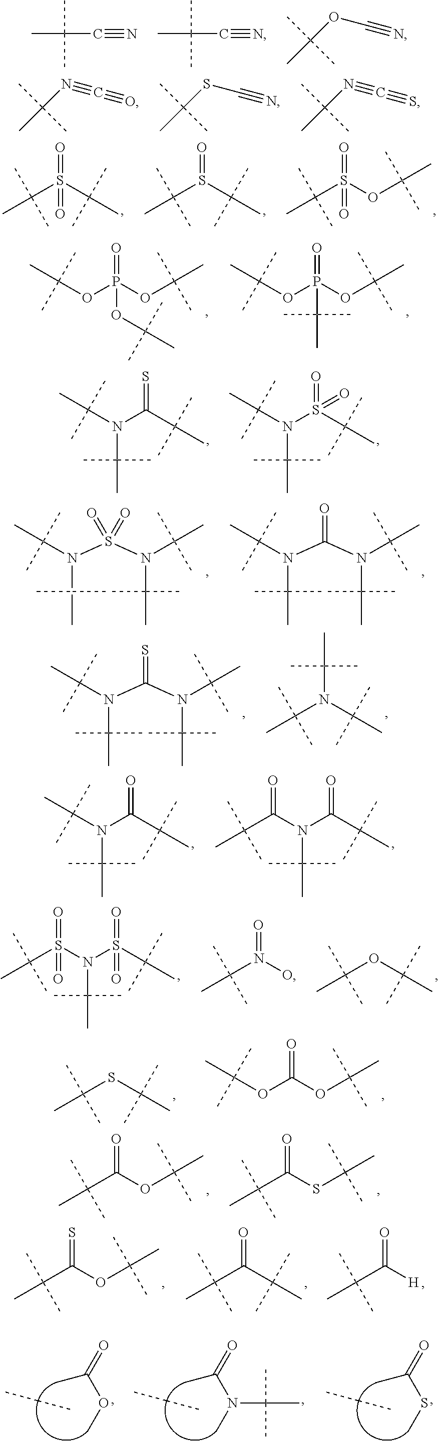 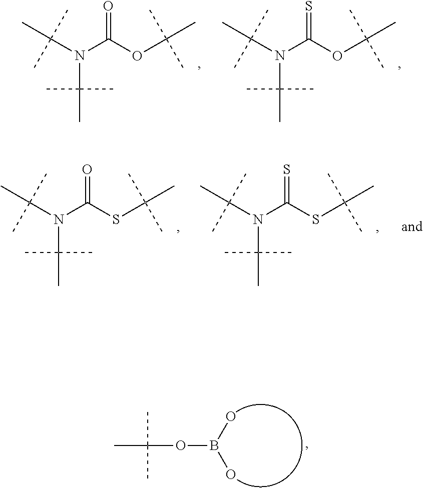
wherein a curved bond denotes a C₂₋₆ alkylene bridging moiety;
wherein the organosilicon compound inhibits degradation reactions within the salt-in-solvent mixture.

25. The stabilized salt-in-solvent mixture of claim 20, wherein the carbonate is selected from the group consisting of ethyl methyl carbonate, dimethyl carbonate, and diethyl carbonate, ethylene carbonate, propylene carbonate, and γ-butyrolactone.

26. The stabilized salt-in-solvent mixture of claim 20, wherein concentration of the organosilicon compound is calculated using the formula:
$$( Vol {\%}_{OS} ) = \frac{[ ppm {H}_{2} O ]}{\begin{matrix}( {ρ}_{OS} ) * ( \frac{1}{M {W}_{OS}} ) * ( \frac{1 mol H F}{1 mol OS} ) * \\ ( \frac{1 mol {H}_{2} O}{2 mol H F} ) * ( M {W}_{H 2 O} ) * ( 1000 ) * ( \frac{1}{{ρ}_{sol}} ) * ( 10 )\end{matrix}}$$
Where Vol %_{OS} is the calculated concentration of organosilicon compound, [ppm H₂O] is the measured concentration of water in the salt-in-solvent mixture, ρ_{OS} is the density of the organosilicon compound, ρₛₒₗ is the density of the solvent mixture, MW_{OS} is the molecular weight of the organosilicon compound, and MW_{H2O} is the molecular weight of water.

27. The stabilized salt-in-solvent mixture of claim 20, wherein the organosilicon compound is selected from the group consisting of:
(R)₄₋ₐ—Si-(Sp-Y)ₐ—Z_{b} (Formula I)
wherein:
“a” is an integer from 1 to 4; “b” is an integer from 0 to (3×a);
“Z,” which is absent when “b”=0, is selected from the group consisting of “R” and 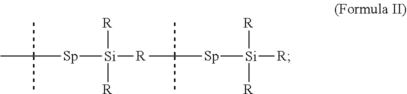
where each “R” is independently selected from the group consisting of halogen, C₁₋₆ linear or branched alkyl, alkenyl, or alkynyl and C₁₋₆ linear or branched halo-alkyl, halo-alkenyl, or halo-alkynyl;
each “Sp” in Formulas I and II is independently selected from the group consisting of C₁₋₁₅ linear or branched alkylenyl and C₁₋₁₅ linear or branched halo-alkylenyl; and
each “Y” in Formula I is independently selected from the group consisting of: 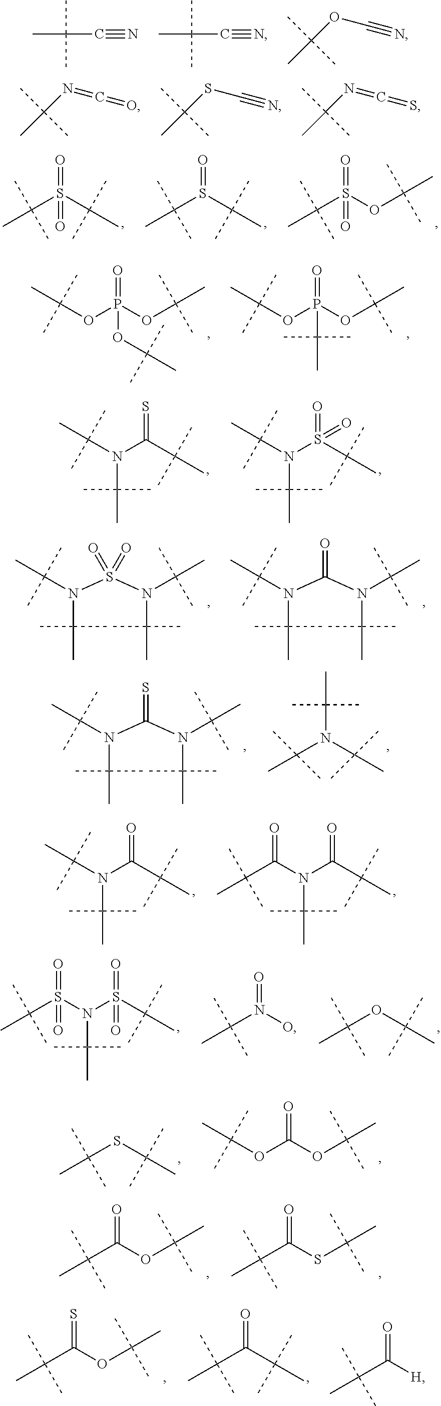 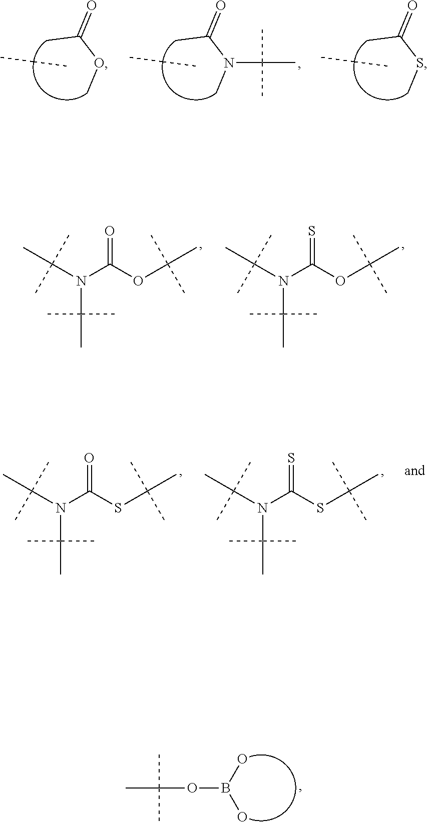
wherein a curved bond denotes a C₂₋₆ alkylene bridging moiety;
wherein the organosilicon compound inhibits degradation reactions within the salt-in-solvent mixture.

28. The stabilized salt-in-solvent mixture of claim 27, wherein the carbonate is selected from the group consisting of ethyl methyl carbonate, dimethyl carbonate, and diethyl carbonate, ethylene carbonate, propylene carbonate, and γ-butyrolactone.
